(19) United States
(12) Patent Application Publication
(10) Pub. No.: US 2026/0122528 A1
(43) Pub. Date: Apr. 30, 2026

(54) TERMINAL DEVICE, NETWORK NODE, AND METHODS THEREIN

(71) Applicant: Telefonaktiebolaget LM Ericsson (publ), Stockholm (SE)

(72) Inventors: Nithin SRINIVASAN, Köln (DE); Antonino ORSINO, Kirkkonummi (FI); Min WANG, Luleå (SE); Zhang ZHANG, Beijing (CN)

(73) Assignee: Telefonaktiebolaget LM Ericsson (publ), Stockholm (SE)

(21) Appl. No.: 18/692,647

(22) PCT Filed: Sep. 16, 2022
(86) PCT No.: PCT/CN2022/119306

§ 371 Date: Mar. 15, 2024

(30) Foreign Application Priority Data
Sep. 17, 2021 (WO) PCT/CN2021/119175
Oct. 1, 2021 (WO) PCT/CN2021/122489

(51) Int. Cl. H04W 28/02; H04W 40/22

(52) U.S. Cl. CPC H04W 28/0268; H04W 28/0278; H04W 40/22

(57) ABSTRACT

The present disclosure provides a method (300) in a first terminal device having a second terminal device as a relay towards a network node or a third terminal device. The method (300) includes: receiving (310), from the network node, the second terminal device, or a control device, a configuration for a service or flow relayed by the second terminal device from/to the first terminal device. The configuration includes at least one of: one or more PC5-Radio Link Control, RLC, channels, one or more Quality of Service, QoS, requirements or parameters and Layer-2 configurations for a first link between the first terminal device and the second terminal device, and one or more mappings each between one or more radio bearers carrying the service or flow and at least one of the one or more PC5-RLC channels.

### TECHNICAL FIELD

The present disclosure relates to communication technology, and more particularly, to a terminal device, a network node, and methods therein for facilitating communications with sidelink relay.

### BACKGROUND

Sidelink (SL) transmissions over New Radio (NR) are specified by the 3^{rd} Generation Partnership Project (3GPP) in Release 16, including enhancements of PROximity-based SErvices (ProSe) specified for Long Term Evolution (LTE). Four new enhancements are particularly introduced to NR sidelink transmissions as follows:
Support for unicast and groupcast transmissions is added in NR sidelink. For unicast and groupcast, a Physical Sidelink Feedback Channel (PSFCH) is introduced for a receiver User Equipment (UE), to reply a decoding status to a transmitter UE.
Grant-free transmissions, which are adopted in NR uplink transmissions, are also provided in the NR sidelink transmissions, to improve the latency performance.
To alleviate resource collisions among different sidelink transmissions launched by different UEs, it enhances channel sensing and resource selection procedures, which also leads to a new design of Physical Sidelink Control Channel (PSCCH).
To achieve a high connection density, congestion control and thus Quality of Service (QoS) management are supported in the NR sidelink transmissions.

Layer 2 (L2) UE-to-Network Relay is defined in the 3GPP Technical Report (TR) 23.752, V17.0.0, which is incorporated herein for reference in its entirety. A protocol architecture supporting an L2 UE-to-Network Relay UE is provided. The L2 UE-to-Network Relay UE, or referred to as relay UE, provides forwarding functionality that can relay any type of traffic over a PC5 link. The L2 UE-to-Network Relay UE provides the functionality to support connectivity to the 5th Generation System (5GS) for Remote UEs. A UE is considered to be a Remote UE if it has successfully established a PC5 link to the L2 UE-to-Network Relay UE. A Remote UE can be located within Next Generation Radio Access Network (NG-RAN) coverage or outside of NG-RAN coverage.

### SUMMARY

According to the 3GPP TR 38.836, V 17.0.0, which is incorporated herein for reference in its entirety, a (next) generation NodeB (gNB) implementation can handle QoS breakdown over Uu and PC5 links for end-to-end QoS enforcement of a particular session established between a Remote UE and a network in case of L2 UE-to-Network Relay. Details of the handling in case PC5 RLC channels with different end-to-end QoS are mapped to the same Uu RLC channel can be discussed in WI (Work Item) phase.

According to the 3GPP TR 23.752, V 17.0.0, which is incorporated herein for reference in its entirety, it is left to RAN Work Group 2 (WG2) and to decide how to support end-to-end QoS between the Remote UE and RAN. In the outcome of the Study Item (SI) for NR Sidelink relays, the following text was based on the agreements during the SI phase:
gNB implementation can handle the QoS breakdown over Uu and PC5 for the end-to-end QoS enforcement of a particular session established between Remote UE and network in case of L2 UE-to-Network Relay. Details of handling in case PC5 RLC channels with different end-to-end QoS are mapped to the same Uu RLC channel can be discussed in WI phase.

Essentially, in case of L2 UE-to-Network relay, the gNB is responsible for QoS breakdown (also called QoS split) over PC5 and Uu links. That is, the gNB is responsible for configuring, at the relay UE, L2 of the PC5 link, L2 of the Uu link, and optionally a mapping of relayed traffic between the PC5 and Uu links. This configuration also involves distributing QoS parameters, such as Packet Delay Budget (PDB) and Packet Error Rate (PER), across the PC5 and Uu links to make sure that end-to-end QoS requirements are satisfied. As a result, it is expected that the gNB provides at least the following configurations to the remote UE and the relay UE as a part of an RRCReconfiguration message:
PC5-Radio Link Control (RLC) channel configuration,
Uu-RLC channel configuration, and
Mapping between PC5-RLC and Uu-RLC channels.

However, in real-time conditions, it may be difficult to maintain the QoS using only the above (PC5 and Uu) RLC configurations, since the mapping configuration is semi-static, meaning that the gNB may not provide reconfigurations too often. This is because the gNB may only consider provisioned rules (e.g., equal split between two links or hops) when performing breakdown of the QoS parameters. However, varying radio channel conditions and lack of computing capacity and sophisticated handling (in terms of buffering, data volume) of the relayed traffic may lead to loss of QoS differentiation between different relayed flows and/or non-relayed flows. In addition, when PC5-RLC channels and Uu-RLC channels are initially established and mapped between each other, the relay UE and/or the remote UE may not be able to provide measurement results and buffer status reports. After they are established, if the gNB realizes that the initial mapping is not suitable any more, e.g., if the end-to-end QoS requirements of the relayed traffic are not satisfied, the gNB may need to perform RRC Reconfiguration to update the respective configurations, leading to significant delays and signaling overhead. In addition, such reconfiguration may also lead to packet drop.

It is an object of the present disclosure to provide terminal devices, a network node, and methods therein, capable of solving or at least mitigating at least one of the above problems, e.g., due to an unsuitable channel mapping between a PC5-RLC channel and Uu RLC channel and design corresponding solutions.

According to a first aspect of the present disclosure, a method in a first terminal device is provided. The first terminal device has a second terminal device as a relay towards a network node or a third terminal device. The method includes: receiving, from the network node, the second terminal device, or a control device, a configuration for a service or flow relayed by the second terminal device from/to the first terminal device. The configuration includes at least one of: one or more PC5-RLC channels, one or more QoS requirements or parameters and Layer-2 configurations for a first link between the first terminal device and the second terminal device, and one or more mappings each between one or more radio bearers carrying the service or flow and at least one of the one or more PC5-RLC channels.

In an exemplary embodiment, the configuration further includes at least one of: one or more Uu-RLC channels,
one or more QoS requirements or parameters and Layer-2 configurations for a second link between the first terminal device and the network node, and one or more mappings each between one or more radio bearers carrying the service or flow and at least one of the one or more Uu-RLC channels.

According to a second aspect of the present disclosure, a first terminal device is provided. The first terminal device includes a transceiver, a processor and a memory. The memory contains instructions executable by the processor whereby the first terminal device is operative to perform the method according to the above first aspect.

According to a third aspect of the present disclosure, a computer readable storage medium is provided. The computer readable storage medium has computer program instructions stored thereon. The computer program instructions, when executed by a processor in a first terminal device, cause the first terminal device to perform the method according to the above first aspect.

According to a fourth aspect of the present disclosure, a method in a second terminal device is provided. The second terminal device serves as a relay for a first terminal device towards a network node or a third terminal device. The method includes: receiving, from the network node or a control device, a configuration for a service or flow relayed by the second terminal device from/to the first terminal device. The configuration includes at least one of: one or more Uu/PC5-RLC channels, one or more QoS requirements or parameters and Layer-2 configurations for a second link between the second terminal device and the network node or the third terminal device, and one or more mappings each between one or more PC5-RLC channels and at least one of the one or more Uu/PC5-RLC channels.

According to a fifth aspect of the present disclosure, a second terminal device is provided. The second terminal device includes a transceiver, a processor and a memory. The memory contains instructions executable by the processor whereby the second terminal device is operative to perform the method according to the above fourth aspect.

According to a sixth aspect of the present disclosure, a computer readable storage medium is provided. The computer readable storage medium has computer program instructions stored thereon. The computer program instructions, when executed by a processor in a second terminal device, cause the second terminal device to perform the method according to the above fourth aspect.

According to a seventh aspect of the present disclosure, a method in a network node or a control device is provided. The method includes: transmitting, to a first terminal device having a second terminal device as a relay towards the network node or a third terminal device, a first configuration for a service or flow relayed by the second terminal device from/to the first terminal device; and/or transmitting, to the second terminal device, a second configuration for the service flow. The first configuration includes at least one of: one or more PC5-RLC channels, one or more QoS requirements or parameters and Layer-2 configurations for a first link between the first terminal device and the second terminal device, and one or more mappings each between one or more radio bearers carrying the service or flow and at least one of the one or more PC5-RLC channels. The second configuration includes at least one of: one or more Uu/PC5-RLC channels, one or more QoS requirements or parameters and Layer-2 configurations for a second link between the second terminal device and the network node or the third terminal device, and one or more mappings each between one or more PC5-RLC channels and at least one of the one or more Uu/PC5-RLC channels.

According to an eighth aspect of the present disclosure, a network node or control device is provided. The network node or control device includes a transceiver, a processor and a memory. The memory contains instructions executable by the processor whereby the network node or control device is operative to perform the method according to the above seventh aspect.

According to a ninth aspect of the present disclosure, a computer readable storage medium is provided. The computer readable storage medium has computer program instructions stored thereon. The computer program instructions, when executed by a processor in a network node or control device, cause the network node or control device to perform the method according to the above seventh aspect.

Furthermore, a measurement framework is proposed that takes into account QoS metrics when performing measurements.

According to this framework, a UE on a relay path may monitor and send measurement results according to configured measurement events, or in a periodical fashion, or when requested/polled. The measurement results are distributed along the relay path. Any or every intermediate node or UE on the path may apply at least one of the following options to handle the received measurement results:
Option 1: forward the measurement results to the next hop without reading the results.
Option 2: read the results, and may update the results (e.g., by appending more measurements), and after that, forward the new results to the next hop.

Upon reception of the measurement results, any UE on the concerned relay path may take proper actions to avoid or recover from potential failure events. In this way, QoS requirement satisfaction can be improved for the concerned flows or services. Further, the QoS breakdown can be handled in a more timely way and the QoS requirement may always be fulfilled even in situation where the channel variations are quite relevant (e.g., in case of mobility).

According to a tenth aspect of the present disclosure, a method performed by a first terminal device is provided. The first terminal device is a node in a relay path that comprises at least two other nodes, the at least two other nodes comprising a second terminal device and at least one of a radio access network, RAN, node and a third terminal device. The method comprises measuring one or more performance metrics of a device-to-device, D2D, connection to one of the terminal devices and/or one or more performance metrics of a connection to the RAN node.

According to an eleventh aspect of the present disclosure, a first terminal device is provided. The first terminal device is configured to operate as a node in a relay path that comprises at least two other nodes, the at least two other nodes comprising a second terminal device and at least one of a radio access network, RAN, node and a third terminal device. The first terminal device is configured to measure one or more performance metrics of a device-to-device, D2D, connection to one of the terminal devices and/or one or more performance metrics of a connection to the RAN node.

According to a twelfth aspect of the present disclosure, a first terminal device is provided. The first terminal device is configured to operate as a node in a relay path that comprises at least two other nodes, the at least two other nodes comprising a second terminal device and at least one of a radio access network, RAN, node and a third terminal device. The first terminal device comprises a processor and a memory, said memory containing instructions executable by said processor whereby said first terminal device is operative to measure one or more performance metrics of a device-to-device, D2D, connection to one of the terminal devices and/or one or more performance metrics of a connection to the RAN node.

According to a thirteenth aspect of the present disclosure, a computer readable storage medium is provided. The computer readable storage medium has computer program instructions stored thereon. The computer program instructions, when executed by a processor in a first terminal device, cause the first terminal device to perform the method according to the above tenth aspect.

According to a fourteenth aspect of the present disclosure, a method performed by a second terminal device is provided. The second terminal device is a node in a relay path that comprises at least two other nodes, the at least two other nodes comprising a first terminal device and at least one of a radio access network, RAN, node and a third terminal device. The method comprises receiving, from one of the other nodes in the relay path, measurements of one or more performance metrics of a device-to-device, D2D, connection to one of the terminal devices and/or one or more performance metrics of a connection to the RAN node.

According to a fifteenth aspect of the present disclosure, a second terminal device is provided. The second terminal device is configured to operate as a node in a relay path that comprises at least two other nodes, the at least two other nodes comprising a first terminal device at least one of and a radio access network, RAN, node and a third terminal device. The second terminal device is configured to receive, from one of the other nodes in the relay path, measurements of one or more performance metrics of a device-to-device, D2D, connection to one of the terminal devices and/or one or more performance metrics of a connection to the RAN node.

According to a sixteenth aspect of the present disclosure, a second terminal device is provided. The second terminal device is configured to operate as a node in a relay path that comprises at least two other nodes, the at least two other nodes comprising a first terminal device and at least one of a radio access network, RAN, node and a third terminal device. The second terminal device comprises a processor and a memory, said memory containing instructions executable by said processor whereby said second terminal device is operative to receive, from one of the other nodes in the relay path, measurements of one or more performance metrics of a device-to-device, D2D, connection and/or one or more performance metrics of a connection to the RAN node.

According to a seventeenth aspect of the present disclosure, a computer readable storage medium is provided. The computer readable storage medium has computer program instructions stored thereon. The computer program instructions, when executed by a processor in a second terminal device, cause the second terminal device to perform the method according to the above fourteenth aspect.

According to an eighteenth aspect of the present disclosure, a method performed by a RAN node is provided. The RAN node is a node in a relay path that comprises at least two other nodes, the at least two other nodes comprising a first terminal device and a second terminal device. The method comprises: receiving, from one of the other nodes in the relay path, measurements of one or more performance metrics of a device-to-device, D2D, connection between the terminal devices and/or one or more performance metrics of a connection to the RAN node.

According to a nineteenth aspect of the present disclosure, a RAN node is provided. The RAN node is configured to operate as a node in a relay path that comprises at least two other nodes, the at least two other nodes comprising a first terminal device and a second terminal device. The RAN node is configured to receive, from one of the other nodes in the relay path, measurements of one or more performance metrics of a device-to-device, D2D, connection between the terminal devices and/or one or more performance metrics of a connection to the RAN node.

According to a twentieth aspect of the present disclosure, a RAN node is provided. The RAN node is configured to operate as a node in a relay path that comprises at least two other nodes, the at least two other nodes comprising a first terminal device and a second terminal device. The RAN node comprises a processor and a memory, said memory containing instructions executable by said processor whereby said RAN node is operative to receive, from one of the other nodes in the relay path, measurements of one or more performance metrics of a device-to-device, D2D, connection between the terminal devices and/or one or more performance metrics of a connection to the RAN node.

According to a twenty-first aspect of the present disclosure, a computer readable storage medium is provided. The computer readable storage medium has computer program instructions stored thereon. The computer program instructions, when executed by a processor in a RAN node, cause the RAN node to perform the method according to the above eighteenth aspect.

Certain embodiments may provide one or more of the following technical advantage(s). For example, with the embodiments of the present disclosure, for a relayed service or flow, a relay UE can receive from a network node a configuration including one or more mappings each between radio bearers and PC5-RLC channels, and a remote UE can receive from a network node a configuration including one or more mappings each between PC5-RLC channels and Uu/PC5-RLC channels. In this way, a more flexible channel mapping can be achieved for the relayed service or flow.

Furthermore, the latency, power consumption and signalling overhead can be improved when performing the discovery procedure in the UE-to-network (NW) and UE-to-UE relay scenarios. In addition, the QoS breakdown can be handled in a more timely way, and the QoS requirement may always be fulfilled even in situations where the channel variations are quite relevant (e.g., in case of mobility). This can be particularly important when the requirements on public safety and vehicle-to-everything (V2X) use cases need to be met.

### BRIEF DESCRIPTION OF THE DRAWINGS

The above and other objects, features and advantages will be more apparent from the following description of embodiments with reference to the figures, in which:

FIG. 1 is a schematic diagram showing a user plane stack for L2 UE-to-Network Relay UE;

FIG. 2 is a schematic diagram showing a control plane stack for L2 UE-to-Network Relay UE;

FIG. 3 is a flowchart illustrating a method in a first terminal device according to an embodiment of the present disclosure;

FIG. 4 is a flowchart illustrating a method in a second terminal device according to an embodiment of the present disclosure;

FIG. 5 is a flowchart illustrating a method in a network node or control device according to an embodiment of the present disclosure;

FIG. 6 is a sequence diagram showing a configuration procedure according to an embodiment of the present disclosure;

FIG. 7 is a block diagram of a first terminal device according to an embodiment of the present disclosure;

FIG. 8 is a block diagram of a second terminal device according to an embodiment of the present disclosure;

FIG. 9 is a block diagram of a network node according to an embodiment of the present disclosure;

FIGS. 10(a), (b) and (c) are simplified illustrations showing three relay scenarios;

FIG. 11 is an example of a communication system in accordance with some embodiments;

FIG. 12 shows a UE/terminal device in accordance with some embodiments;

FIG. 13 shows a RAN node in accordance with some embodiments;

FIG. 14 is a block diagram illustrating a virtualization environment in which functions implemented by some embodiments may be virtualized;

FIG. 15 is a flow chart illustrating a method in a first terminal device in accordance with some embodiments;

FIG. 16 is a flow chart illustrating a method in a second terminal device in accordance with some embodiments; and

FIG. 17 is a flow chart illustrating a method in a RAN node in accordance with some embodiments.

FIG. 18 schematically illustrates a telecommunication network connected via an intermediate network to a host computer;

FIG. 19 is a generalized block diagram of a host computer communicating via a base station with a user equipment over a partially wireless connection; and

FIGS. 20 to 23 are flowcharts illustrating methods implemented in a communication system including a host computer, a base station and a user equipment.

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network node in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or a (next) generation NodeB (gNB), a Remote Radio Unit (RRU), a radio header (RH), a remote radio head (RRH), a relay, a low power node such as a femto, a pico, and so forth. Yet further examples of the network node may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network node may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably, which may include a “wireless device”. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from the network node to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

Although the embodiments described herein are in the context of NR, i.e. two or more sidelink (SL) UEs are deployed in a same or different NR cell. However, the same principles/technique can be applied to LTE or any other technology that enables the direct connection of two (or more) nearby terminal devices. The embodiments are also applicable to other relay scenarios including a UE-to-network (U2N) relay or UE-to-UE (U2U) relay, where the link between a remote UE and a relay UE may be based on LTE sidelink or NR sidelink, i.e. the Uu connection between a relay UE and a base station (eNB or gNb as appropriate) may be LTE Uu or NR Uu. The embodiments are particularly applicable to L2 based U2N or U2U relay scenarios where E2E QoS requirements need to be maintained.

The term “direct” when used with “connection” or “path” refers to a connection between a UE and a gNB, while the term “indirect” when used with “connection” or “path” refers to a connection between a remote UE and gNB via a relay UE. A “relay path” as used herein is considered to include at least a direct connection between a UE and a gNB (or other RAN node), and at least one indirect connection between the UE and another UE. Further, the terms “relay traffic” or “relay service/flow” refer to the traffic originating at the remote UE and the terms “non-relay traffic” or “non-relay service/flow” to refer to the traffic originating at the relay UE itself. More generally, the terms “traffic”, “service” and “flow” are used herein to refer to traffic on any hop between UEs or between a UE and a gNB (or other RAN node).

In the following embodiments, unless otherwise indicated, reference to a terminal device or a UE refers to either a remote UE or a relay UE.

Generally, a L2 U2N Relay UE (referred to herein as a “relay UE”) can provide forwarding functionality that can relay traffic over a PC5 link, and can also provide the functionality to support connectivity to the 5G System (5GS) for one or more remote UEs. A UE can be considered to be a remote UE if the UE has successfully established a PC5 link to the relay UE. A remote UE can be located within next generation radio access network (NG-RAN) coverage, or outside of NG-RAN coverage (i.e. the remote UE may or may not have coverage from the radio access network (RAN)).

To enable the enhancements to NR sidelink transmissions as described above, new physical channels and reference signals are introduced in NR:
Physical Sidelink Shared Channel (PSSCH), a sidelink version of Physical Downlink Shared Channel (PDSCH): The PSSCH is transmitted by a sidelink transmitter UE, and conveys sidelink transmission data, System Information Blocks (SIBs) for Radio Resource Control (RRC) configuration, and a part of Sidelink Control Information (SCI).
PSFCH, a sidelink version of Physical Uplink Control Channel (PUCCH): The PSFCH is transmitted by a sidelink receiver UE for unicast and groupcast, and conveys 1 bit information over 1 Resource Block (RB) for a Hybrid Automatic Repeat reQuest (HARQ) acknowledgement (ACK) or negative ACK (NACK). In addition, Channel State Information (CSI) is carried in a Medium Access Control (MAC) Control Element (CE) over the PSSCH instead of the PSFCH.
PSCCH, a sidelink version of Physical Downlink Control Channel (PDCCH): When traffic to be transmitted to a receiver UE arrives at a transmitter UE, a transmitter UE should first transmit the PSCCH, which conveys a part of SCI to be decoded by any UE for the channel sensing purpose, including reserved time-frequency resources for transmissions, DeModulation Reference Signal (DMRS) pattern and antenna port, etc.
Sidelink Primary/Secondary Synchronization Signal (S-PSS/S-SSS): Similar to downlink transmissions in NR, in sidelink transmissions, S-PSS and S-SSS are supported. Through detecting the S-PSS and S-SSS, a UE is able to identify a Sidelink Synchronization Identity (SSID) from the UE transmitting the S-PSS/S-SSS. Through detecting the S-PSS/S-SSS, the UE is therefore able to know the characteristics of the transmitter UE from the S-PSS/S-SSS. A series of processes of acquiring timing and frequency synchronization together with SSIDs of UEs is called initial cell search. Note that the UE transmitting the S-PSS/S-SSS may not be necessarily involved in sidelink transmissions, and a node (e.g., UE, evolved NodeB (eNB), or (next) generation NodeB (gNB)) transmitting the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a Synchronization Signal/PSBCH Block (SSB). The SSB has the same numerology as PSCCH/PSSCH on a carrier, and an SSB should be transmitted within the bandwidth of a configured Bandwidth Part (BWP). The PSBCH conveys information related to synchronization, such as Direct Frame Number (DFN), an indication of slot and symbol level time resources for sidelink transmissions, in-coverage indicator, etc. The SSB is transmitted periodically every 160 ms.
DMRS, Phase Tracking Reference Signal (PT-RS), Channel State Information Reference Signal (CSIRS): These physical reference signals supported by NR downlink/uplink transmissions are also adopted by sidelink transmissions. Similarly, the PT-RS is only applicable for Frequency Range 2 (FR2) transmission.

Another new feature is a two-stage Sidelink Control Information (SCI). This is a version of the Downlink Control Information (DCI) for sidelink. Unlike the DCI, only part (first stage) of the SCI is sent on the PSCCH. This part is used for channel sensing purposes (including the reserved time-frequency resources for transmissions, DMRS pattern and antenna port, etc.) and can be read by all UEs, while the remaining (second stage) scheduling and control information, such as a 8-bits source IDentity (ID) and a 16-bits destination ID, a New Data Indicator (NDI), a Redundancy Version (RV), and a HARQ process ID is sent on the PSSCH to be decoded by the receiver UE.

Similar as for PROSE in LTE, NR sidelink transmissions have the following two modes of resource allocations:
Mode 1: Sidelink resources are scheduled by a gNB.
Mode 2: The UE autonomously selects sidelink resources from one or more (pre)configured sidelink resource pools based on a channel sensing mechanism.

For an in-coverage UE, a gNB can be configured to adopt Mode 1 or Mode 2. For an out-of-coverage UE, only Mode 2 can be adopted.

As in LTE, scheduling over the sidelink in NR is done in different ways for Mode 1 and Mode 2.

Mode 1 supports the following two types of grants:
Dynamic grant: When traffic to be transmitted over sidelink arrives at a transmitter UE, the UE should initiate a four-message exchange procedure to request sidelink resources from a gNB (Scheduling Request (SR) on Uplink (UL), grant, Buffer Status Report (BSR) on UL, grant for data on Sidelink (SL) transmitted to UE). During a resource request procedure, the gNB may allocate a Sidelink Radio Network Temporary Identifier (SL-RNTI) to the transmitter UE. If this sidelink resource request is granted by the gNB, then the gNB indicates the resource allocation for the PSCCH and the PSSCH in the DCI conveyed by PDCCH with Cyclic Redundancy Check (CRC) scrambled with the SL-RNTI. When the transmitter UE receives such DCI, the transmitter UE can obtain the grant only if the scrambled CRC of DCI can be successfully solved by the assigned SL-RNTI. The transmitter UE then indicates time-frequency resources and transmission scheme of the allocated PSSCH in the PSCCH, and transmits the PSCCH and the PSSCH on the allocated resources for sidelink transmissions. When the grant is obtained from the gNB, the transmitter UE can only transmit a single Transport Block (TB). As a result, this type of grant is suitable for traffic with a loose latency requirement.
Configured grant: For traffic with a strict latency requirement, performing the four-message exchange procedure to request sidelink resources may induce unacceptable latency. In this case, before traffic arrives, a transmitter UE may perform the four-message exchange procedure and request a set of resources. If a grant can be obtained from a gNB, then the requested resources are reserved in a periodic manner. When the traffic arrives at the transmitter UE, the UE can transmit the PSCCH and the PSSCH on an upcoming resource occasion. In fact, this type of grant is also known as grant-free transmissions.

In both dynamic grant and configured grant, a sidelink receiver UE cannot receive the DCI (since it is addressed to the transmitter UE), and therefore the receiver UE should perform blind decoding to identify the presence of PSCCH and find the resources for the PSSCH based on the SCI.

When the transmitter UE transmits the PSCCH, CRC is also inserted in the SCI without any scrambling.

In Mode 2, when traffic arrives at a transmitter UE, the transmitter UE should autonomously select resources for the PSCCH and the PSSCH. To further minimize the latency of the feedback HARQ ACK/NACK transmissions and subsequently retransmissions, the transmitter UE may also reserve resources for PSCCH/PSSCH for retransmissions. To further enhance the probability of successful TB decoding at one shot and thus suppress the probability to perform retransmissions, the transmitter UE may repeat the TB transmission in addition to the initial TB transmission. This mechanism is also known as blind retransmission. As a result, when traffic arrives at the transmitter UE, the transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore provided for Mode 2 based on channel sensing algorithm. The channel sensing algorithm involves measuring Reference Signal Received Power (RSRP) on different subchannels and requires knowledge of the different UEs' power levels of the DMRS on the PSSCH or the DMRS on the PSCCH depending on a configuration. This information is known only after receiving the SCI transmitted by (all) other UEs. The sensing and selection algorithm is rather complex.

FIG. 1 shows a user plane protocol stack for an L2 UE-to-Network Relay UE, related to a Protocol Data Unit (PDU) Session. The PDU layer corresponds to the PDU carried between the Remote UE and the Data Network (DN) over the PDU session. It is important to note that two endpoints of a Packet Data Convergence Protocol (PDCP) link are the Remote UE and the gNB. A relay function is performed below PDCP. This means that data security is ensured between the Remote UE and the gNB without exposing raw data at the L2 UE-to-Network Relay UE.

The adaptation rely layer within the user plane stack for the L2 UE-to-Network Relay UE can differentiate between Signaling Radio Bearers (SRBs) and Data Radio Bearers (DRBs) for a particular Remote UE. The adaption relay layer is also responsible for mapping PC5 traffic to one or more DRBs of the Uu. The definition of the adaptation relay layer is under the responsibility of RAN Work Group 2 (WG2).

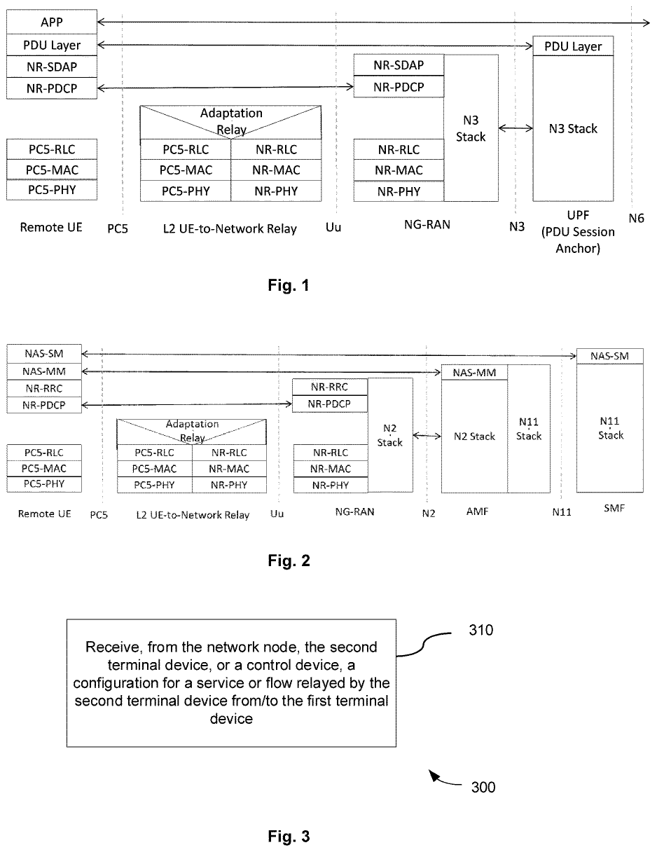

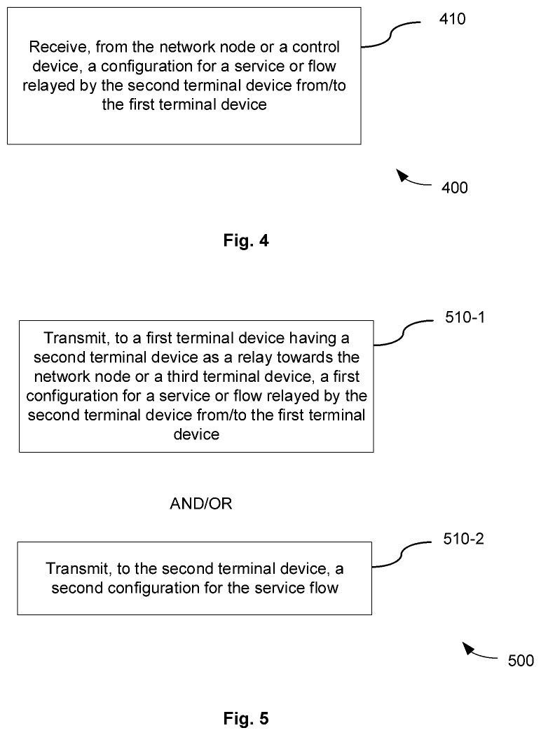

FIG. 2 shows a control plane protocol stack for an L2 UE-to-Network Relay UE, which illustrates a Non-Access Stratum (NAS) connection for a Remote UE to NAS Mobility Management (NAS-MM) and NAS Management (NAS-SM) components. The NAS messages are transparently transferred between the Remote UE and 5G Radio Access Network (5G-RAN) over the L2 UE-to-Network Relay UE using:
PDCP end-to-end connection where the role of the L2 UE-to-Network Relay UE is to relay PDUs over an SRB without any modifications.
N2 connection between the 5G-RAN and Access and Mobility Management Function (AMF) over N2.
N11 connection between the AMF and Session Management Function (SMF) over N11.

The role of the L2 UE-to-Network Relay UE is to relay the PDUs from the SRB without any modifications.

FIG. 3 shows a flowchart illustrating a method 300 according to an embodiment of the present disclosure. The method 300 can be performed at a first terminal device (e.g., a remote UE). The first terminal device has a second terminal device (e.g., a relay UE) serving as a relay towards a network node (e.g., a gNB, in case of UE-to-Network relay) or a third terminal device (e.g., a destination UE, in case of UE-to-UE relay).

At block 310, the first terminal device receives, from the network node (e.g., in case of UE-to-Network relay), the second terminal device (e.g., in case of UE-to-UE relay), or a control device (e.g., a trusted control UE or a Road Side Unit (RSU) in a Vehicle-to-Everything (V2X) scenario, e.g., in case of UE-to-UE relay), a configuration for a service or flow relayed by the second terminal device from/to the first terminal device. The configuration includes at least one of:
one or more PC5-RLC channels,
one or more QoS requirements or parameters and Layer-2 configurations (e.g., RLC, MAC, and/or Physical layer (PHY)) for a first link (e.g., PC5 link) between the first terminal device and the second terminal device, and
one or more mappings each between one or more radio bearers (e.g., PC5/Uu Signaling Radio Bearers (SRBs) or Data Radio Bearers (DRBs)) carrying the service or flow and at least one of the one or more PC5-RLC channels.

Alternatively or additionally, the configuration may further include at least one of:
one or more Uu-RLC channels,
one or more QoS requirements or parameters and Layer-2 configurations for a second link between the first terminal device and the network node (e.g., in a case where the Uu-RLC channels are setup), and
one or more mappings each between one or more radio bearers carrying the service or flow and at least one of the one or more Uu-RLC channels.

Here, the one or more mappings may include at least one of: a mapping between one radio bearer and one PC5-RLC and/or Uu-RLC channel, a mapping between more than one radio bearer and one PC5-RLC and/or Uu-RLC channel, or a mapping between one radio bearer and more than one PC5-RLC and/or Uu-RLC channel.

In an example, the one or more PC5-RLC and/or Uu-RLC channels may be associated with a same carrier or different carriers (e.g., in case of Carrier Aggregation (CA)). The one or more PC5-RLC channels may be set up with different Layer-2 configurations, e.g., different priority levels.

In an example, each of the one or more PC5-RLC channels may be for the service or flow only, or may be shared between the service or flow and another non-relayed service or flow. Here, a “non-relayed” service or flow refers to a service or flow transmitted directly from/to the first terminal device over a PC5 or Uu link.

In an example, the first terminal device may transmit, to the network node, the second terminal device, or the control device, information on the service or flow and/or one or more other relayed or non-relayed services or flows. Here, for each service or flow, the information may include at least one of:
a type of the service or flow, e.g., V2X or public safety,
one or more QoS requirements or parameters, e.g., PDB or PER,
a transmission direction, e.g., uplink or downlink,
power related information of the first terminal device, e.g., transmitting or receiving power, Power Headroom (PHR), or battery status,
an identifier of the first terminal device, or
an identifier of the second terminal device.

In an example, the first terminal device may select at least one mapping from the one or more mappings for the service or flow, and transmit one or more Packet Data Convergence Protocol (PDCP) Protocol Data Units (PDUs) carrying the service or flow over the at least one PC5-RLC and/or Uu-RLC channel in the selected at least one mapping. For example, the at least one mapping may be selected based on at least one condition or measurement for the first link and/or the second link, and/or at least one threshold associated with the at least one condition or measurement. Here, the at least one condition or measurement may include:
one or more short term radio channel conditions, e.g., Reference Signal Received Quality (RSRQ), Reference Signal Received Power (RSRP), Received Signal Strength Indication (RSSI), Signal to Interference plus Noise Ratio (SINR), Signal to Interference Ratio (SIR), etc.,
one or more short term congestion metrics, e.g., Channel Busy Ratio (CBR), or Channel Usage Ratio (CR),
one or more Layer-1 measurements, e.g., Hybrid Automatic Repeat reQuest (HARQ) Negative Acknowledgement (NACK) ratio,
one or more QoS metrics, e.g., packet loss, packet delay, PER, etc.,
a buffer status,
a power headroom or power efficiency,
a mobility status of the first terminal device, e.g., moving speed,
a location of the first terminal device, or
a need for a link reconfiguration.

The selection may be performed once for every M^{th} PDCP PDU carrying the service or flow or at a period, where M (which is a positive integer) and the period may be configured by the network node, the second terminal device, or the control device, or may be preconfigured.

In an example, the first terminal device can transmit, to the second terminal device, a mapping indication indicating the selected at least one mapping. When the selected at least one mapping includes a PC5-RLC channel that is sharable between the service or flow and another non-relayed service or flow, the first terminal device can transmit, to the second terminal device, a traffic indication indicating whether the PC5-RLC channel is for relayed traffic or non-relayed traffic. Here, the mapping indication and/or the traffic indication may be carried in a Buffer Status Report (BSR), an adaptation layer header, or a Medium Access Control (MAC) header. The traffic indication may indicate whether the PC5-RLC channel is for relayed traffic or non-relayed traffic by using: different Logical Channel Groups (LCGs), for relayed traffic and non-relayed traffic, a field in a BSR MAC Control Element (CE), or different Logical Channel Identifiers (LCIDs), for relayed traffic and non-relayed traffic.

In an example, the first terminal device may receive, from the second terminal device, an indication of at least one mapping between at least one of the one or more PC5-RLC channels and at least one Uu/PC5-RLC channel.

Here, for example, for uplink transmission, the first terminal device can transmit the mapping indication to the second terminal device, and then the second terminal device can select the mapping(s) between the PC5-RLC channel(s) and the Uu/PC5-RLC channel(s) accordingly. For downlink transmission, the first terminal device can receive the indication from the second terminal device, and then select the mapping(s) between the radio bearer(s) and the PC5-RLC channel(s) accordingly.

In an example, the first terminal device may start a timer when the mapping indication is transmitted, and the one or more PDCP PDUs may be transmitted after the timer expires. For example, the timer may be configured by the network node, the second terminal device, or the control device, or may be pre-configured or hardcoded in a specification).

In an example, at least one of the one or more PC5-RLC channels that is not included in the selected at least one mapping may be suspended or deactivated. For example, there may be the following options:
Option 1: All of the one or more configured PC5-RLC channels are allowed to be active at the same time;
Option 2: Only some of the one or more configured PC5-RLC channels are allowed to be active at the same time; and
Option 3: Only one of the one or more configured PC5-RLC channels is allowed to be active at the same time.

Which of the options the first terminal device is to take may be decided directly by the network node, the second terminal device, or the control device that transmits the configuration, or by the first terminal device based on rules configured by the network node, the second terminal device, or the control device, or predefined in the first terminal device. It is to be noted that even if the first terminal device receives a configuration to set up a number of PC5-RLC channels, those not to be used may not be physically set up, but the configuration is rather stored at the first terminal device. A PC5-RLC channel may be set up or resumed/reactivated only when it is really needed, i.e., when the first terminal device determines to select/reselect it.

In an example, the one or more mappings may include a first mapping between a first radio bearer and a first PC5-RLC or Uu-RLC channel and a second mapping between the first radio bearer and a second PC5-RLC or Uu-RLC channel. Here, the first PC5-RLC or Uu-RLC channel is dedicated for the service or flow and the second PC5-RLC or Uu-RLC channel is sharable between the service or flow and another non-relayed service or flow. The first terminal device may select the first mapping or the second mapping based on a first priority of the first PC5-RLC or Uu-RLC channel and a second priority of the second PC5-RLC or Uu-RLC channel. For example, the first priority may be higher than the second priority when a QoS of the service or flow is prioritized over power efficiency of the first terminal device, or the first priority may be lower than the second priority when the power efficiency of the first terminal device is prioritized over the QoS of the service or flow.

In another example, when a first mapping between a first radio bearer and a first PC5-RLC or Uu-RLC channel is selected (the first PC5-RLC or Uu-RLC channel is dedicated for the service or flow), the first terminal device may reselect, from the one or more mappings, a second mapping between the first radio bearer and a second PC5-RLC channel, or reselect a third PC5-RLC or Uu-RLC channel to which the first radio bearer is to be mapped. Here, the second PC5-RLC or Uu-RLC channel is sharable between the service or flow and another non-relayed service or flow. The third PC5-RLC or Uu-RLC channel is included in none of the one or more mappings and is sharable between the service or flow and another non-relayed service or flow. The third PC5-RLC or Uu-RLC channel is a PC5-RLC or Uu-RLC channel that already exists (i.e., has been set up) at the time of reselecting. Here, the second mapping may be reselected or the third PC5-RLC or Uu-RLC channel may be reselected when: a real-time PDB or PER on the first or the second link is higher than or lower than a threshold, a buffer capacity of the first terminal device is higher than or lower than a threshold, and/or power efficiency or batter power of the first terminal device is higher than or lower than a threshold. For example, the second mapping may be reselected or the third PC5-RLC/Uu-RLC channel may be reselected when the first PC5-RLC/Uu-RLC channel is unavailable due to reconfiguration of the first or the second link (e.g., by an RRCReconfiguration message), in response to: an update of a PC5 Layer-2 configuration for the first link or a Uu Layer-2 configuration for the second link, and/or an update of a QoS parameter over the first or the second link.

In an example, the first terminal device may transmit, to the second terminal device, an indication of at least one condition or measurement for the first link and/or the second link, and/or receive, from the second terminal device, an indication of at least one condition or measurement for at least one of the first link, the second link, and a third link (Uu link or PC5 link) between the second terminal device and the network node or the third terminal device. Here, the at least one condition or measurement may include:
one or more short term radio channel conditions, e.g., RSRQ, RSRP, RSSI, SINR, SIR, etc.,
one or more short term congestion metrics, e.g., CBR or CR,
one or more Layer-1 measurements, e.g., HARQ NACK ratio,
one or more QoS metrics, e.g., packet loss, packet delay, PER, etc.,
a buffer status,
a power headroom or power efficiency,
a mobility status of the first or second terminal device, e.g., moving speed,
a location of the first or second terminal device, or
a need for a link reconfiguration.

The above condition or measurement may be used in selecting the second mapping (or second PC5-RLC or Uu-RLC channel) or the third PC5-RLC or Uu-RLC channel at the first terminal device.

FIG. 4 shows a flowchart illustrating a method 400 according to an embodiment of the present disclosure. The method 400 can be performed at a second terminal device (e.g., a relay UE). The second terminal device as a relay for a first terminal device (e.g., a remote UE) towards a network node (e.g., a gNB, in case of UE-to-Network relay) or a third terminal device (e.g., a destination UE, in case of UE-to-UE relay).

At block 410, the second terminal device receives, from the network node (e.g., in case of UE-to-Network relay) or a control device (e.g., a trusted control UE or an RSU in a V2X scenario, e.g., in case of UE-to-UE relay), a second configuration for a service or flow relayed by the second terminal device from/to the first terminal device. The second configuration includes at least one of: one or more Uu/PC5-RLC channels, one or more QoS requirements or parameters and Layer-2 configurations for a third link between the second terminal device and the network node or the third terminal device, and one or more mappings each between one or more PC5-RLC channels and at least one of the one or more Uu/PC5-RLC channels. In this context, the notation “Uu/PC5-RLC channel” means Uu-RLC channel, e.g., in case of UE-to-Network relay, or PC5-RLC channel, e.g., in case of UE-to-UE relay.

Here, the one or more mappings may include at least one of: a mapping between one PC5-RLC channel and one Uu/PC5-RLC channel, a mapping between more than one PC5-RLC channel and one Uu/PC5-RLC channel, or a mapping between one PC5-RLC channel and more than one Uu/PC5-RLC channel.

In an example, the one or more Uu/PC5-RLC channels may be associated with a same network node or carrier, or with different network nodes or carriers (e.g., in case of CA), the different network nodes using a same Radio Access Technology, RAT, or different RATs (e.g., in case of Dual Connectivity (DC), including EUTRAN-NR DC (EN-DC) or NR-EUTRAN DC (NE-DC)). The one or more Uu/PC5-RLC channels may be set up with different Layer-2 configurations, e.g., different priority levels.

In an example, each of the one or more Uu/PC5-RLC channels may be for the service or flow only, or is shared between the service or flow and another non-relayed service or flow.

In an example, the second terminal device may forward, to the first terminal device, configuration of the network node for the first terminal device, e.g., in a case where the PC5-RLC channel between the first terminal device and the second terminal device (i.e., an indirect path) is setup first. In this case, the Uu-RLC channel between the first terminal device and the network node is setup via the second terminal device.

Accordingly, the second terminal device may receive, from the network node or the control device, a first configuration for the service or flow relayed by the second terminal device from/to the first terminal device. The first configuration includes at least one of: one or more PC5-RLC and/or Uu-RLC channels, one or more QoS requirements or parameters and Layer-2 configurations for a first link between the first terminal device and the second terminal device and/or a second link between the first terminal device and the network node, and one or more mappings each between one or more radio bearers carrying the service or flow and at least one of the one or more PC5-RLC and/or Uu-RLC channels; and forward the first configuration to the first terminal device.

In an example, the one or more mappings in the first configuration may include at least one of: a mapping between one radio bearer and one PC5-RLC and/or Uu-RLC channel, a mapping between more than one radio bearer and one PC5-RLC and/or Uu-RLC channel, or a mapping between one radio bearer and more than one PC5-RLC and/or Uu-RLC channel.

In an example, the one or more PC5-RLC and/or Uu-RLC channels are associated with a same carrier or different carriers.

In an example, each of the one or more PC5-RLC channels is for the service or flow only, or is shared between the service or flow and another non-relayed service or flow.

In an example, the second terminal device may transmit, to the network node or the control device, information on the service or flow and/or one or more other relayed or non-relayed services or flows. Here, for each service or flow, the information may include at least one of:
a type of the service or flow, e.g., V2X or public safety,
one or more QoS requirements or parameters, e.g., PDB or PER,
a transmission direction, e.g., uplink or downlink,
power related information of the first terminal device or the second terminal device, e.g., transmitting or receiving power, PHR, or battery status,
an identifier of the first terminal device, or
an identifier of the second terminal device.

In an example, the second terminal device may select at least one mapping in the second configuration from the one or more mappings for the service or flow, and transmit one or more PDCP PDUs of the first terminal device carrying the service or flow over the at least one Uu/PC5-RLC channel in the selected at least one mapping. For example, the at least one mapping may be selected based on at least one condition or measurement for at least one of a first link between the first terminal device and the second terminal device, a second link between the first terminal device and the network node, and the third link, and/or at least one threshold associated with the at least one condition or measurement. Here, the at least one condition or measurement may include:
one or more short term radio channel conditions, e.g., RSRQ, RSRP, RSSI, SINR, SIR, etc.,
one or more short term congestion metrics, e.g., CBR or CR,
one or more Layer-1 measurements, e.g., HARQ NACK ratio,
one or more QoS metrics, e.g., packet loss, packet delay, PER, etc.,
a buffer status,
a power headroom or power efficiency,
a mobility status of the second terminal device, e.g., moving speed,
a location of the second terminal device, or
a need for a link reconfiguration.

The selection may be performed once for every M^{th} PDCP PDU of the first terminal device carrying the service or flow or at a period, where M (which is a positive integer) and the period may be configured by the network node or the control device, or may be preconfigured.

In an example, the second terminal device may transmit, to the network node or the control device, a mapping indication indicating the selected at least one mapping. When the selected at least one mapping includes a Uu/PC5-RLC channel that is sharable between the service or flow and another non-relayed service or flow, the second terminal device may transmit, to the network node or the control device, a traffic indication indicating whether the Uu/PC5-RLC channel is for relayed traffic or non-relayed traffic. Here, the mapping indication and/or the traffic indication may be carried in a BSR, an adaptation layer header, or a MAC header. The traffic indication may indicate whether the Uu/PC5-RLC channel is for relayed traffic or non-relayed traffic by using: different LCGs for relayed traffic and non-relayed traffic, a field in a BSR MAC CE, or different LCIDs for relayed traffic and non-relayed traffic.

In an example, the second terminal device may receive, from the first terminal device, an indication of at least one mapping between at least one radio bearer carrying the service or flow and at least one of the one or more PC5-RLC channel.

Here, for example, for downlink transmission, the second terminal device can transmit the mapping indication to the first terminal device, and then the first terminal device can select the mapping(s) between the radio bearer(s) and the PC5-RLC channel(s) accordingly. For uplink transmission, the second terminal device can receive the indication from the first terminal device, and then select the mapping(s) between the PC5-RLC channel(s) and the Uu/PC5-RLC channel(s) accordingly.

In an example, the second terminal device may start a timer when the mapping indication is transmitted, and the one or more PDCP PDUs may be transmitted after the timer expires. For example, the timer may be configured by the network node or the control device, or may be pre-configured or hardcoded in a specification).

In an example, at least one of the one or more Uu/PC5-RLC channels that is not included in the selected at least one mapping may be suspended or deactivated. For example, there may be the following options:
Option 1: All of the one or more configured Uu/PC5-RLC channels are allowed to be active at the same time;
Option 2: Only some of the one or more configured Uu/PC5-RLC channels are allowed to be active at the same time; and
Option 3: Only one of the one or more configured Uu/PC5-RLC channels is allowed to be active at the same time.

Which of the options the second terminal device is to take may be decided directly by the network node or the control device that transmits the configuration, or by the second terminal device based on rules configured by the network node or the control device, or predefined in the second terminal device. It is to be noted that even if the second terminal device receives a configuration to set up a number of Uu/PC5-RLC channels, those not to be used may not be physically set up, but the configuration is rather stored at the second terminal device. A Uu/PC5-RLC channel may be set up or resumed/reactivated only when it is really needed, i.e., when the second terminal device determines to select/reselect it.

In an example, the one or more mappings in the second configuration may include a first mapping between a first PC5-RLC channel and a first Uu/PC5-RLC channel and a second mapping between the first PC5-RLC channel and a second Uu/PC5-RLC channel. Here, the first Uu/PC5-RLC channel is dedicated for the service or flow and the second Uu/PC5-RLC channel is sharable between the service or flow and another non-relayed service or flow. The second terminal device may select the first mapping or the second mapping based on a first priority of the first Uu/PC5-RLC channel and a second priority of the second Uu/PC5-RLC channel. For example, the first priority may be higher than the second priority when a QoS of the service or flow is prioritized over power efficiency of the first terminal device, or the first priority may be lower than the second priority when the power efficiency of the first terminal device is prioritized over the QoS of the service or flow.

In another example, when a first mapping between a first PC5-RLC channel and a first Uu/PC5-RLC channel is selected (the first Uu/PC5-RLC channel is dedicated for the service or flow), the second terminal device may reselect, from the one or more mappings, a second mapping between the first PC5-RLC channel and a second Uu/PC5-RLC channel, or reselect a third Uu/PC5-RLC channel to which the first PC5-RLC channel is to be mapped. Here, the second Uu/PC5-RLC channel is sharable between the service or flow and another non-relayed service or flow. The third Uu/PC5-RLC channel is included in none of the one or more mappings and is sharable between the service or flow and another non-relayed service or flow. The third Uu/PC5-RLC channel is a Uu/PC5-RLC channel that already exists (i.e., has been set up) at the time of reselecting. Here, the second mapping may be reselected or the third Uu/PC5-RLC channel may be reselected when: a real-time PDB or PER on the first link or the third link is higher than or lower than a threshold, a buffer capacity of the second terminal device is higher than or lower than a threshold, and/or power efficiency or batter power of the second terminal device is higher than or lower than a threshold. For example, the second mapping may be reselected or the third Uu/PC5-RLC channel may be reselected when the first Uu/PC5-RLC channel is unavailable due to reconfiguration of the first link (e.g., by an RRCReconfiguration message), in response to: an update of a Uu/PC5 Layer-2 configuration for the third link, and/or an update of a QoS parameter over the third link.

In an example, the second terminal device may transmit, to the first terminal device, an indication of at least one condition or measurement for the first link and/or the third link, and/or receive, from the first terminal device, an indication of at least one condition or measurement for the first link and/or the second link. Here, the at least one condition or measurement may include:
one or more short term radio channel conditions, e.g., RSRQ, RSRP, RSSI, SINR, SIR, etc.,
one or more short term congestion metrics, e.g., CBR or CR,
one or more Layer-1 measurements, e.g., HARQ NACK ratio,
one or more QoS metrics, e.g., packet loss, packet delay, PER, etc.,
a buffer status,
a power headroom or power efficiency,
a mobility status of the first or second terminal device, e.g., moving speed,
a location of the first or second terminal device, or
a need for a link reconfiguration.

The above condition or measurement may be used in selecting the second mapping (or second Uu/PC5-RLC channel) or the third Uu/PC5-RLC channel at the second terminal device.

FIG. 5 shows a flowchart illustrating a method 500 according to an embodiment of the present disclosure. The method 500 can be performed at a network node (e.g., a gNB, in case of UE-to-Network relay) or a control device (e.g., a trusted control UE or an RSU in a V2X scenario, e.g., in case of UE-to-UE relay).

At block 510-1, the network node or control device transmits, to a first terminal device (e.g., a remote UE) having a second terminal device (e.g., a relay UE) as a relay towards the network node or a third terminal device (e.g., a destination UE, in case of UE-to-UE relay), a first configuration for a service or flow relayed by the second terminal device from/to the first terminal device. The first configuration includes at least one of: one or more PC5-RLC channels, one or more QoS requirements or parameters and Layer-2 configurations for a first link between the first terminal device and the second terminal device, and one or more mappings each between one or more radio bearers carrying the service or flow and at least one of the one or more PC5-RLC channels.

Alternatively or additionally, at block 510-2, the network node or control device transmits, to the second terminal device, a second configuration for the service flow. The second configuration includes at least one of: one or more Uu/PC5-RLC channels, one or more QoS requirements or parameters and Layer-2 configurations for a third link between the second terminal device and the network node or the third terminal device, and one or more mappings each between one or more PC5-RLC channels and at least one of the one or more Uu/PC5-RLC channels.

In an example, the first configuration may further include at least one of: one or more Uu-RLC channels, one or more QoS requirements or parameters and Layer-2 configurations for a second link between the first terminal device and the network node, and one or more mappings each between one or more radio bearers carrying the service or flow and at least one of the one or more Uu-RLC channels.

In an example, the first configuration may be transmitted to the first terminal device via the second terminal device.

Here, the one or more mappings in the first configuration may include at least one of: a mapping between one radio bearer and one PC5-RLC and/or Uu-RLC channel, a mapping between more than one radio bearer and one PC5-RLC and/or Uu-RLC channel, or a mapping between one radio bearer and more than one PC5-RLC and/or Uu-RLC channel. The one or more mappings in the second configuration may include at least one of: a mapping between one PC5-RLC channel and one Uu/PC5-RLC channel, a mapping between more than one PC5-RLC channel and one Uu/PC5-RLC channel, or a mapping between one PC5-RLC channel and more than one Uu/PC5-RLC channel.

In an example, the network node or control device may receive, from the first terminal device or the second terminal device, information on the service or flow and/or one or more other relayed or non-relayed services or flows. The first configuration and/or the second configuration may be determined based on the information. Here, for each service or flow, the information may include at least one of:
a type of the service or flow, e.g., V2X or public safety,
one or more QoS requirements or parameters, e.g., PDB or PER,
a transmission direction, e.g., uplink or downlink,
power related information of the first or second terminal device, e.g., transmitting or receiving power, PHR, or battery status,
an identifier of the first terminal device, or
an identifier of the second terminal device.

The network node may perform QoS breakdown (with respect to one or more QoS parameters such as PDB and/or PER) between the first link and the second link for the service or flow (in uplink, downlink, or both) based on the received information.

In an example, the network node or control device may receive, from the second terminal device, a mapping indication indicating at least one mapping selected from the one or more mapping in the second configuration. When the selected at least one mapping includes a Uu/PC5-RLC channel that is sharable between the service or flow and another non-relayed service or flow, the network node or control device may further receive, from the second terminal device, a traffic indication indicating whether the Uu/PC5-RLC channel is for relayed traffic or non-relayed traffic. Here, the mapping indication and/or the traffic indication may be carried in a BSR, an adaptation layer header, or a MAC header. The traffic indication may indicate whether the Uu/PC5-RLC channel is for relayed traffic or non-relayed traffic by using: different LCGs for relayed traffic and non-relayed traffic, a field in a BSR MAC CE, or different LCIDs for relayed traffic and non-relayed traffic.

In the above methods 300, 400, and 500, the communication/signaling between any terminal device (e.g., the first terminal device or the second terminal device) and any network node may be transmitted/received via Radio Resource Control RRC signaling, MAC CE, paging message, Layer-1 (L1) signaling (e.g., on channels such as PSSCH, PSCCH, or PSFCH), or control PDU of a protocol layer (e.g., Service Data Adaptation Protocol (SDAP), PDCP, RLC or an adaptation layer in case of sidelink relay).

In the above methods 300, 400, and 500, the communication/signaling between any two terminal devices (e.g., the first terminal device or the second terminal device) may be transmitted/received via RRC signaling (e.g., PC5-RRC), PC5-S, discovery signaling, MAC CE, L1 signaling (e.g., on a channel such as Physical Random Access Channel (PRACH), PUCCH, or PDCCH), or control PDU of a protocol layer (e.g., SDAP, PDCP, RLC or an adaptation layer in case of sidelink relay).

It can be appreciated that the above methods 300, 400, and 500 can also be applied to multi-hop UE-to-Network or UE-to-UE relay.

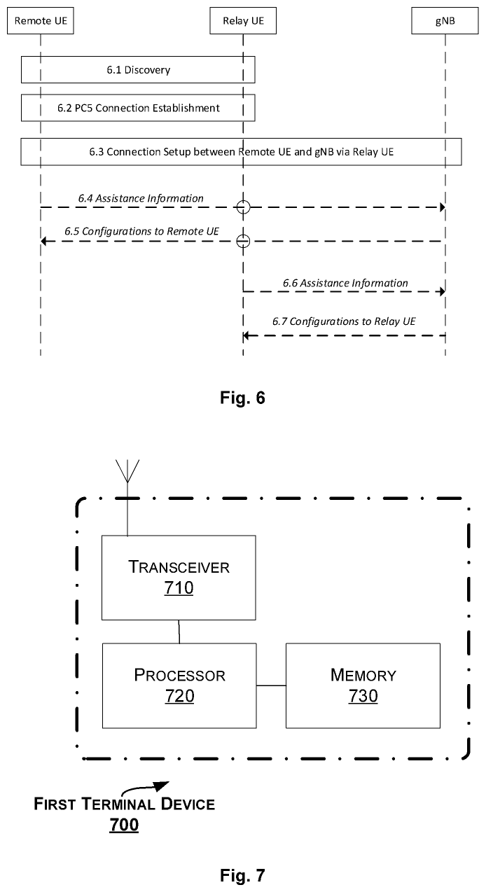

FIG. 6 shows a configuration procedure according to an embodiment of the present disclosure. As shown, at 6.1, a remote UE discovers a relay UE, and at 6.2, the remote UE establishes a PC5 connection with the relay UE. At 6.3, a connection is set up between the remote UE and a gNB via the relay UE. At 6.4, the remote UE transmits assistance information to the gNB via the relay UE. The assistance information may include, for a service or flow, at least one of: a type of the service or flow, one or more QoS requirements or parameters, a transmission direction, power related information of the remote UE, an identifier of the remote UE, or an identifier of the relay UE, as described above in connection with the method 300. At 6.5, the gNB transmits a configuration to the remote UE via the relay UE, including one or more PC5-RLC channels, one or more QoS requirements or parameters and Layer-2 configurations, and one or more mappings each between one or more radio bearers carrying the service or flow and at least one of the one or more PC5-RLC channels, as described above in connection with the method 300. Alternatively or additionally, at 6.6, the relay UE transmits assistance information to the gNB. The assistance information may include, for a service or flow, at least one of: a type of the service or flow, one or more QoS requirements or parameters, a transmission direction, power related information of the relay UE, an identifier of the remote UE, or an identifier of the relay UE, as described above in connection with the method 400. At 6.7, the gNB transmits a configuration to the relay UE, including one or more Uu/PC5-RLC channels, one or more QoS requirements or parameters and Layer-2 configurations for a second link between the second terminal device and the network node or the third terminal device, and one or more mappings each between one or more PC5-RLC channels and at least one of the one or more Uu/PC5-RLC channels., as described above in connection with the method 400.

FIG. 7 shows a block diagram of a first terminal device 700 according to an embodiment of the present disclosure.

The first terminal device has a second terminal device as a relay towards a network node or a third terminal device.

The first terminal device 700 includes a transceiver 710, a processor 720 and a memory 730. The memory 730 may contain instructions executable by the processor 720 whereby the first terminal device 700 is operative to perform the actions, e.g., of the procedure described earlier in conjunction with FIG. 3. Particularly, the memory 730 contains instructions executable by the processor 720 whereby the first terminal device 700 is operative to: receive, from the network node, the second terminal device, or a control device, a configuration for a service or flow relayed by the second terminal device from/to the first terminal device. The configuration may include at least one of: one or more PC5-RLC channels, one or more QOS requirements or parameters and Layer-2 configurations for a first link between the first terminal device and the second terminal device, and one or more mappings each between one or more radio bearers carrying the service or flow and at least one of the one or more PC5-RLC channels.

Alternatively or additionally, the configuration may further include at least one of:
one or more Uu-RLC channels,
one or more QoS requirements or parameters and Layer-2 configurations for a second link between the first terminal device and the network node (e.g., in a case where the Uu-RLC channels are setup), and
one or more mappings each between one or more radio bearers carrying the service or flow and at least one of the one or more Uu-RLC channels.

In an embodiment, the one or more mappings may include at least one of: a mapping between one radio bearer and one PC5-RLC and/or Uu-RLC channel, a mapping between more than one radio bearer and one PC5-RLC and/or Uu-RLC channel, or a mapping between one radio bearer and more than one PC5-RLC and/or Uu-RLC channel.

In an embodiment, the one or more PC5-RLC and/or Uu-RLC channels may be associated with a same carrier or different carriers.

In an embodiment, each of the one or more PC5-RLC channels may be for the service or flow only, or may be shared between the service or flow and another non-relayed service or flow.

In an embodiment, the memory 730 may further contain instructions executable by the processor 720 whereby the first terminal device 700 is operative to: transmit, to the network node, the second terminal device, or the control device, information on the service or flow and/or one or more other relayed or non-relayed services or flows.

In an embodiment, the information may include, for each service or flow, at least one of:
a type of the service or flow,
one or more QoS requirements or parameters,
a transmission direction,
power related information of the first terminal device,
an identifier of the first terminal device, or
an identifier of the second terminal device.

In an embodiment, the memory 730 may further contain instructions executable by the processor 720 whereby the first terminal device 700 is operative to: select at least one mapping from the one or more mappings for the service or flow; and transmit one or more PDCP PDUs carrying the service or flow over the at least one PC5-RLC and/or Uu-RLC channel in the selected at least one mapping.

In an embodiment, the at least one mapping may be selected based on at least one condition or measurement for the first link and/or the second link, and/or at least one threshold associated with the at least one condition or measurement. The at least one condition or measurement may include:
one or more short term radio channel conditions,
one or more short term congestion metrics,
one or more Layer-1 measurements,
one or more QoS metrics,
a buffer status,
a power headroom or power efficiency,
a mobility status of the first terminal device,
a location of the first terminal device, or
a need for a link reconfiguration.

In an embodiment, the memory 730 may further contain instructions executable by the processor 720 whereby the first terminal device 700 is operative to: transmit, to the second terminal device, a mapping indication indicating the selected at least one mapping.

In an embodiment, the memory 730 may further contain instructions executable by the processor 720 whereby the first terminal device 700 is operative to: when the selected at least one mapping includes a PC5-RLC channel that is sharable between the service or flow and another non-relayed service or flow: transmit, to the second terminal device, a traffic indication indicating whether the PC5-RLC channel is for relayed traffic or non-relayed traffic.

In an embodiment, the mapping indication and/or the traffic indication may be carried in a BSR, an adaptation layer header, or a MAC header.

In an embodiment, the traffic indication may indicate whether the PC5-RLC channel is for relayed traffic or non-relayed traffic by using: different LCGs for relayed traffic and non-relayed traffic, a field in a BSR MAC CE, or different LCIDs for relayed traffic and non-relayed traffic.

In an embodiment, the memory 730 may further contain instructions executable by the processor 720 whereby the first terminal device 700 is operative to: start a timer when the mapping indication is transmitted. The one or more PDCP PDUs may be transmitted after the timer expires.

In an embodiment, the memory 730 may further contain instructions executable by the processor 720 whereby the first terminal device 700 is operative to: receive, from the second terminal device, an indication of at least one mapping between at least one of the one or more PC5-RLC channels and at least one Uu/PC5-RLC channel.

In an embodiment, at least one of the one or more PC5-RLC channels that is not included in the selected at least one mapping may be suspended or deactivated.

In an embodiment, the one or more mappings may include a first mapping between a first radio bearer and a first PC5-RLC or Uu-RLC channel and a second mapping between the first radio bearer and a second PC5-RLC or Uu-RLC channel, the first PC5-RLC or Uu-RLC channel being dedicated for the service or flow and the second PC5-RLC or Uu-RLC channel being sharable between the service or flow and another non-relayed service or flow. The operation of selecting may include: selecting the first mapping or the second mapping based on a first priority of the first PC5-RLC or Uu-RLC channel and a second priority of the second PC5-RLC or Uu-RLC channel.

In an embodiment, the first priority may be higher than the second priority when a QoS of the service or flow is prioritized over power efficiency of the first terminal device, or the first priority may be lower than the second priority when the power efficiency of the first terminal device is prioritized over the QoS of the service or flow.

In an embodiment, the memory 730 may further contain instructions executable by the processor 720 whereby the first terminal device 700 is operative to: when a first mapping between a first radio bearer and a first PC5-RLC or Uu-RLC channel is selected, the first PC5-RLC or Uu-RLC channel being dedicated for the service or flow: reselect, from the one or more mappings, a second mapping between the first radio bearer and a second PC5-RLC or Uu-RLC channel, the second PC5-RLC or Uu-RLC channel being sharable between the service or flow and another non-relayed service or flow, or reselect a third PC5-RLC or Uu-RLC channel to which the first radio bearer is to be mapped, the third PC5-RLC or Uu-RLC channel being included in none of the one or more mappings and being sharable between the service or flow and another non-relayed service or flow.

In an embodiment, the second mapping may be reselected or the third PC5-RLC or Uu-RLC channel is reselected when:
a real-time PDB or PER on the first link is higher than or lower than a threshold,
a buffer capacity of the first terminal device is higher than or lower than a threshold, and/or
power efficiency or batter power of the first terminal device is higher than or lower than a threshold.

In an embodiment, the second mapping may be reselected or the third PC5-RLC or Uu-RLC channel may be reselected when the first PC5-RLC or Uu-RLC channel is unavailable due to reconfiguration of the first or the second link, in response to: an update of a PC5 Layer-2 configuration for the first link or a Uu Layer-2 configuration for the second link, and/or an update of a QoS parameter over the first or the second link.

In an embodiment, the memory 730 may further contain instructions executable by the processor 720 whereby the first terminal device 700 is operative to: transmit, to the second terminal device, an indication of at least one condition or measurement for the first link and/or the second link, and/or receive, from the second terminal device, an indication of at least one condition or measurement for at least one of the first link, the second link, and a third link between the second terminal device and the network node or the third terminal device. The at least one condition or measurement may include: one or more short term radio channel conditions, one or more short term congestion metrics, one or more Layer-1 measurements, one or more QOS metrics, a buffer status, a power headroom or power efficiency, a mobility status of the first terminal device or the second terminal device, a location of the first terminal device or the second terminal device, or a need for a link reconfiguration.

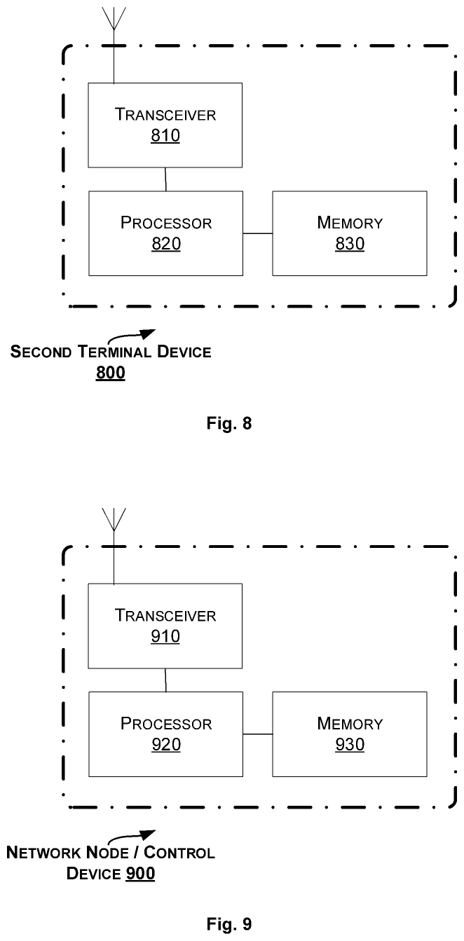

FIG. 8 shows a block diagram of a second terminal device 800 according to an embodiment of the present disclosure.

The second terminal device serves as a relay for a first terminal device towards a network node or a third terminal device.

The second terminal device 800 includes a transceiver 810, a processor 820 and a memory 830. The memory 830 may contain instructions executable by the processor 820 whereby the second terminal device 800 is operative to perform the actions, e.g., of the procedure described earlier in conjunction with FIG. 4. Particularly, the memory 830 contains instructions executable by the processor 820 whereby the second terminal device 800 is operative to: receive, from the network node or a control device, a second configuration for a service or flow relayed by the second terminal device from/to the first terminal device. The second configuration includes at least one of: one or more Uu/PC5-RLC channels, one or more QoS requirements or parameters and Layer-2 configurations for a third link between the second terminal device and the network node or the third terminal device, and one or more mappings each between one or more PC5-RLC channels and at least one of the one or more Uu/PC5-RLC channels.

In an embodiment, the one or more mappings may include at least one of: a mapping between one PC5-RLC channel and one Uu/PC5-RLC channel, a mapping between more than one PC5-RLC channel and one Uu/PC5-RLC channel, or a mapping between one PC5-RLC channel and more than one Uu/PC5-RLC channel.

In an embodiment, the one or more Uu/PC5-RLC channels may be associated with a same network node or carrier, or with different network nodes or carriers, the different network nodes using a same RAT or different RATs.

In an embodiment, each of the one or more Uu/PC5-RLC channels may be for the service or flow only, or may be shared between the service or flow and another non-relayed service or flow.

In an embodiment, the second terminal device may forward, to the first terminal device, configuration of the network node for the first terminal device, e.g., in a case where the PC5-RLC channel between the first terminal device and the second terminal device (i.e., an indirect path) is setup first. In this case, the Uu-RLC channel between the first terminal device and the network node is setup via the second terminal device.

Accordingly, the memory 830 contains instructions executable by the processor 820 whereby the second terminal device 800 is operative to receive, from the network node or the control device, a first configuration for the service or flow relayed by the second terminal device from/to the first terminal device. The first configuration includes at least one of: one or more PC5-RLC and/or Uu-RLC channels, one or more QoS requirements or parameters and Layer-2 configurations for a first link between the first terminal device and the second terminal device and/or a second link between the first terminal device and the network node, and one or more mappings each between one or more radio bearers carrying the service or flow and at least one of the one or more PC5-RLC and/or Uu-RLC channels; and forward the first configuration to the first terminal device.

In an example, the one or more mappings in the first configuration may include at least one of: a mapping between one radio bearer and one PC5-RLC and/or Uu-RLC channel, a mapping between more than one radio bearer and one PC5-RLC and/or Uu-RLC channel, or a mapping between one radio bearer and more than one PC5-RLC and/or Uu-RLC channel.

In an example, the one or more PC5-RLC and/or Uu-RLC channels are associated with a same carrier or different carriers.

In an example, each of the one or more PC5-RLC channels is for the service or flow only, or is shared between the service or flow and another non-relayed service or flow.

In an embodiment, the memory 830 may further contain instructions executable by the processor 820 whereby the second terminal device 800 is operative to: transmit, to the network node or the control device, information on the service or flow and/or one or more other relayed or non-relayed services or flows.

In an embodiment, the information may include, for each service or flow, at least one of:
a type of the service or flow,
one or more QoS requirements or parameters,
a transmission direction,
power related information of the first terminal device or the second terminal device,
an identifier of the first terminal device, or
an identifier of the second terminal device.

In an embodiment, the memory 830 may further contain instructions executable by the processor 820 whereby the second terminal device 800 is operative to: select at least one mapping in the second configuration from the one or more mappings for the service or flow; and transmit one or more PDCP PDUs of the first terminal device carrying the service or flow over the at least one Uu/PC5-RLC channel in the selected at least one mapping.

In an embodiment, the at least one mapping may be selected based on at least one condition or measurement for at least one of a first link between the first terminal device and the second terminal device, a second link between the first terminal device and the network node, and the third link, and/or at least one threshold associated with the at least one condition or measurement. The at least one condition or measurement may include:
one or more short term radio channel conditions,
one or more short term congestion metrics,
one or more Layer-1 measurements,
one or more QoS metrics,
a buffer status,
a power headroom or power efficiency,
a mobility status of the second terminal device,
a location of the second terminal device, or
a need for a link reconfiguration.

In an embodiment, the memory 830 may further contain instructions executable by the processor 820 whereby the second terminal device 800 is operative to: transmit, to the network node or the control device, a mapping indication indicating the selected at least one mapping.

In an embodiment, the memory 830 may further contain instructions executable by the processor 820 whereby the second terminal device 800 is operative to: when the selected at least one mapping includes a Uu/PC5-RLC channel that is sharable between the service or flow and another non-relayed service or flow: transmit, to the network node or the control device, a traffic indication indicating whether the Uu/PC5-RLC channel is for relayed traffic or non-relayed traffic.

In an embodiment, the mapping indication and/or the traffic indication may be carried in a BSR, an adaptation layer header, or a MAC header.

In an embodiment, the traffic indication may indicate whether the Uu/PC5-RLC channel is for relayed traffic or non-relayed traffic by using: different LCGs for relayed traffic and non-relayed traffic, a field in a BSR MAC CE, or different LCIDs for relayed traffic and non-relayed traffic.

In an embodiment, the memory 830 may further contain instructions executable by the processor 820 whereby the second terminal device 800 is operative to: start a timer when the mapping indication is transmitted. The one or more PDCP PDUs may be transmitted after the timer expires.

In an embodiment, the memory 830 may further contain instructions executable by the processor 820 whereby the second terminal device 800 is operative to: receive, from the first terminal device, an indication of at least one mapping between at least one radio bearer carrying the service or flow and at least one of the one or more PC5-RLC channel.

In an embodiment, at least one of the one or more Uu/PC5-RLC channels that is not included in the selected at least one mapping may be suspended or deactivated.

In an embodiment, the one or more mappings in the second configuration may include a first mapping between a first PC5-RLC channel and a first Uu/PC5-RLC channel and a second mapping between the first PC5-RLC channel and a second Uu/PC5-RLC channel, the first Uu/PC5-RLC channel being dedicated for the service or flow and the second Uu/PC5-RLC channel being sharable between the service or flow and another non-relayed service or flow. The operation of selecting may include: selecting the first mapping or the second mapping based on a first priority of the first Uu/PC5-RLC channel and a second priority of the second Uu/PC5-RLC channel.

In an embodiment, the first priority may be higher than the second priority when a QoS of the service or flow is prioritized over power efficiency of the first terminal device, or the first priority may be lower than the second priority when the power efficiency of the first terminal device is prioritized over the QoS of the service or flow.

In an embodiment, the memory 830 may further contain instructions executable by the processor 820 whereby the second terminal device 800 is operative to: when a first mapping between a first PC5-RLC channel and a first Uu/PC5-RLC channel is selected, the first Uu/PC5-RLC channel being dedicated for the service or flow: reselect, from the one or more mappings, a second mapping between the first PC5-RLC channel and a second Uu/PC5-RLC channel, the second Uu/PC5-RLC channel being sharable between the service or flow and another non-relayed service or flow, or reselect a third Uu/PC5-RLC channel to which the first PC5-RLC channel is to be mapped, the third Uu/PC5-RLC channel being included in none of the one or more mappings and being sharable between the service or flow and another non-relayed service or flow.

In an embodiment, the second mapping may be reselected or the third Uu/PC5-RLC channel may be reselected when:
a real-time PDB or PER on the first link or the third link is higher than or lower than a threshold,
a buffer capacity of the second terminal device is higher than or lower than a threshold, and/or
power efficiency or batter power of the second terminal device is higher than or lower than a threshold.

In an embodiment, the second mapping may be reselected or the third Uu/PC5-RLC channel may be reselected when the first Uu/PC5-RLC channel is unavailable due to reconfiguration of the third link, in response to: an update of a Uu/PC5 Layer-2 configuration for the third link, and/or an update of a QoS parameter over the third link.

In an embodiment, the memory 830 may further contain instructions executable by the processor 820 whereby the second terminal device 800 is operative to: transmit, to the first terminal device, an indication of at least one condition or measurement for a first link between the first terminal device and the second terminal device and/or the third link, and/or receive, from the first terminal device, an indication of at least one condition or measurement for the first link and/or the second link. The at least one condition or measurement may include: one or more short term radio channel conditions, one or more short term congestion metrics, one or more Layer-1 measurements, one or more QoS metrics, a buffer status, a power headroom or power efficiency, a mobility status of the first terminal device or the second terminal device, a location of the first terminal device or the second terminal device, or a need for a link reconfiguration.

FIG. 9 shows a block diagram of a network node or control device 900 according to an embodiment of the present disclosure.

The network node or control device 900 includes a transceiver 910, a processor 920 and a memory 930. The memory 930 may contain instructions executable by the processor 920 whereby the network node or control device 900 is operative to perform the actions, e.g., of the procedure described earlier in conjunction with FIG. 5. Particularly, the memory 930 contains instructions executable by the processor 920 whereby the network node or control device 900 is operative to: transmit, to a first terminal device having a second terminal device as a relay towards the network node or a third terminal device, a first configuration for a service or flow relayed by the second terminal device from/to the first terminal device; and/or transmit, to the second terminal device, a second configuration for the service flow. The first configuration includes at least one of: one or more PC5-RLC channels, one or more QoS requirements or parameters and Layer-2 configurations for a first link between the first terminal device and the second terminal device, and one or more mappings each between one or more radio bearers carrying the service or flow and at least one of the one or more PC5-RLC channels. The second configuration includes at least one of: one or more Uu/PC5-RLC channels, one or more QoS requirements or parameters and Layer-2 configurations for a third link between the second terminal device and the network node or the third terminal device, and one or more mappings each between one or more PC5-RLC channels and at least one of the one or more Uu/PC5-RLC channels.

In an embodiment, the first configuration may further include at least one of: one or more Uu-RLC channels, one or more QoS requirements or parameters and Layer-2 configurations for a second link between the first terminal device and the network node, and one or more mappings each between one or more radio bearers carrying the service or flow and at least one of the one or more Uu-RLC channels.

In an embodiment, the first configuration may be transmitted to the first terminal device via the second terminal device.

In an embodiment, the one or more mappings in the first configuration may include at least one of: a mapping between one radio bearer and one PC5-RLC and/or Uu-RLC channel, a mapping between more than one radio bearer and one PC5-RLC and/or Uu-RLC channel, or a mapping between one radio bearer and more than one PC5-RLC and/or Uu-RLC channel, and/or the one or more mappings in the second configuration may include at least one of: a mapping between one PC5-RLC channel and one Uu/PC5-RLC channel, a mapping between more than one PC5-RLC channel and one Uu/PC5-RLC channel, or a mapping between one PC5-RLC channel and more than one Uu/PC5-RLC channel.

In an embodiment, the memory 930 may further contain instructions executable by the processor 920 whereby the network node or control device 900 is operative to: receive, from the first terminal device or the second terminal device, information on the service or flow and/or one or more other relayed or non-relayed services or flows. The first configuration and/or the second configuration may be determined based on the information.

In an embodiment, the information may include, for each service or flow, at least one of:
a type of the service or flow,
one or more QoS requirements or parameters,
a transmission direction,
power related information of the first terminal device or the second terminal device,
an identifier of the first terminal device, or
an identifier of the second terminal device.

In an embodiment, the memory 930 may further contain instructions executable by the processor 920 whereby the network node or control device 900 is operative to: receive, from the second terminal device, a mapping indication indicating at least one mapping selected from the one or more mapping in the second configuration.

In an embodiment, the memory 930 may further contain instructions executable by the processor 920 whereby the network node or control device 900 is operative to: when the selected at least one mapping includes a Uu/PC5-RLC channel that is sharable between the service or flow and another non-relayed service or flow: receive, from the second terminal device, a traffic indication indicating whether the Uu/PC5-RLC channel is for relayed traffic or non-relayed traffic.

In an embodiment, the mapping indication and/or the traffic indication may be carried in a BSR, an adaptation layer header, or a MAC header.

In an embodiment, the traffic indication may indicate whether the Uu/PC5-RLC channel is for relayed traffic or non-relayed traffic by using: different LCGs for relayed traffic and non-relayed traffic, a field in a BSR MAC CE, or different LCIDs for relayed traffic and non-relayed traffic.

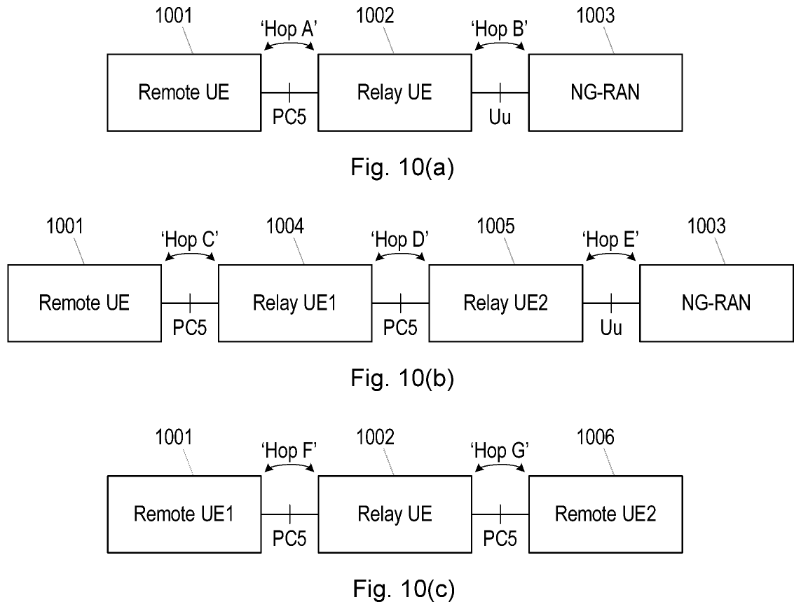

FIGS. 10(a), (b) and (c) illustrate three different arrangements in a relay scenario. FIG. 10(a) illustrates a UE-to-network relay arrangement of a remote UE, a relay UE and a base station in a relay scenario that comprises two ‘hops’. Thus, FIG. 10(a) shows a remote UE 1001 that is connected via a relay UE 1002 (e.g. a ProSe UE-to-Network Relay) to the NG-RAN 1003. The connection between the remote UE 1001 and the relay UE 1002 is referred to as a ‘hop’ and is labelled ‘Hop A’. The connection between the relay UE 1002 and the NG-RAN 1003 is also referred to as a hop, and is labelled ‘Hop B’. The NG-RAN 1003 can be a NR RAN, and more specifically the NG-RAN 1003 can be a base station, such as a gNB or eNB. The relay UE 1002 can be a dedicated relay device, or a typical UE that can selectively operate as a relay UE 1002. In the case of a 3GPP technology-based relay scenario, the interface between the remote UE 1001 and the relay UE 1002 can be a PC5 interface, and the interface between the relay UE 1002 and the NG-RAN 1003 is the Uu interface. The relay UE entity 1002 provides the functionality to support connectivity to the NG-RAN 1003 for remote UEs 1001. It can be used for both public safety services and commercial services (e.g. an interactive service).

FIG. 10(b) illustrates another UE-to-network relay arrangement of a relay scenario, which involves three UEs, and includes three ‘hops’. Thus, FIG. 10(b) shows a remote UE 1001 that is connected via a first relay UE 1004 (‘Relay UE1’) (e.g. a ProSe UE-to-Network Relay) and a second relay UE 1005 (‘Relay UE2’) to the NG-RAN 1003. The connection between the remote UE 1001 and relay UE1 1004 is labelled ‘Hop C’. The connection between relay UE1 1004 and relay UE2 1005 is labelled ‘Hop D’. The connection between relay UE 1005 and the NG-RAN 1003 is labelled ‘Hop E’. The NG-RAN 1003 can be a NR RAN, and more specifically the NG-RAN 1003 can be a base station, such as a gNB or eNB. One or both of the relay UEs 1004, 1005 can be a dedicated relay device, or a typical UE that can selectively operate as a relay UE. In the case of a 3GPP technology-based relay scenario, the interface between the remote UE 1001 and the relay UE1 1004 can be a PC5 interface, the interface between relay UE1 1004 and relay UE2 1005 can be a PC5 interface, and the interface between the relay UE 1002 and the NG-RAN 1003 is the Uu interface. The relay UE entities 1004, 1005 provide the functionality to support connectivity to the NG-RAN 1003 for remote UEs 1001. It can be used for both public safety services and commercial services (e.g. an interactive service).

FIG. 10(c) illustrates a UE-to-UE relay arrangement of a first remote UE, a relay UE and a second remote UE in a relay scenario that comprises two ‘hops’. Thus, FIG. 10(c) shows a first remote UE 1001 that is connected via a relay UE 1002 to a second remote UE 1006. The connection between the first remote UE 1001 and the relay UE 1002 is labelled ‘Hop F’. The connection between the relay UE 1002 and the second remote UE 1006 is labelled ‘Hop G’. The relay UE 1002 can be a dedicated relay device, or a typical UE that can selectively operate as a relay UE 1002. In the case of a 3GPP technology-based relay scenario, the interface between the first remote UE 1001 and the relay UE 1002, and the interface between the second remote UE 1006 and the relay UE 1002 can be a PC5 interface. The relay UE entity 1002 provides the functionality to support connectivity between the remote UEs 1001, 1006. It can be used for both public safety services and commercial services (e.g. an interactive service).

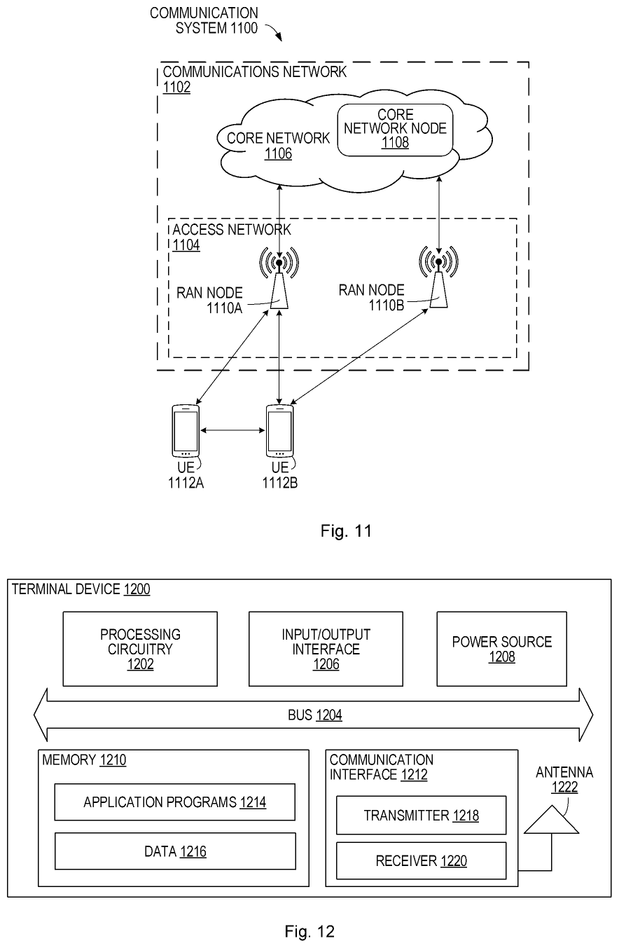

FIG. 11 shows an example of a communication system 1100 in accordance with some embodiments in which the techniques can be implemented.

In the example, the communication system 1100 includes a communication network 1102 that includes an access network 1104, such as a radio access network (RAN), and a core network 1106, which includes one or more core network nodes 1108. The access network 1104 includes one or more radio access network (RAN) nodes, such as RAN nodes 1110a and 1110b (one or more of which may be generally referred to as RAN nodes 1110), or any other similar 3rd Generation Partnership Project (3GPP) access node or non-3GPP access point. The RAN nodes 1110 facilitate direct or indirect connection of terminal devices (also referred to interchangeably herein as user equipment (UE)), such as by connecting UEs 1112a and 1112b (one or more of which may be generally referred to as UEs 1112) to the core network 1106 over one or more wireless connections. The RAN nodes 1110 may be, for example, access points (APs) (e.g. radio access points), base stations (BSs) (e.g. radio base stations, Node Bs, evolved Node Bs (eNBs) and NR NodeBs (gNBs)).

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The terminal devices/UEs 1112 may be any of a wide variety of communication devices, including terminal devices arranged, configured, and/or operable to communicate wirelessly with the RAN nodes 1110 and other communication devices, including other terminal devices/UEs 1112. Thus, the terminal devices 1112 can be configured to communicate directly with other terminal devices 1112 using a device to device (D2D) communication technique/protocol. The D2D communication technique/protocol may be Sidelink (SL). A terminal device 1112 may also or alternatively be configured to use D2D communication techniques/protocols to act as a relay terminal device for another terminal device 1112 that does not have connectivity (or full connectivity) to the communication network 1102.

The RAN nodes 1110 are arranged, capable, configured, and/or operable to communicate directly or indirectly with the UEs 1112 and/or with other network nodes or equipment in the communication network 1102 to enable and/or provide network access, such as wireless network access, and/or to perform other functions, such as administration in the communication network 1102.

The core network 1106 includes one more core network nodes (e.g. core network node 1108) that are structured with hardware and software components. Features of these components may be substantially similar to those described with respect to the terminal devices/UEs, and/or access network nodes, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

As a whole, the communication system 1100 of FIG. 11 enables connectivity between the terminal devices/UEs, and network nodes. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the communication network 1102 is a cellular network that implements 3GPP standardized features. Accordingly, the communications network 1102 may support network slicing to provide different logical networks to different devices that are connected to the communication network 1102. For example, the communications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

FIG. 12 shows a terminal device or UE 1200 in accordance with some embodiments. As used herein, a UE refers to a device capable, configured, arranged and/or operable to communicate wirelessly with network nodes and/or other UEs. Examples of a terminal device/UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated terminal device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A terminal device/UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X), including for the purpose of acting as a relay UE/terminal device for another UE/terminal device. In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g. a smart sprinkler controller). Alternatively, a UE may represent a device that is not intended for sale to, or operation by, an end user but which may be associated with or operated for the benefit of a user (e.g. a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

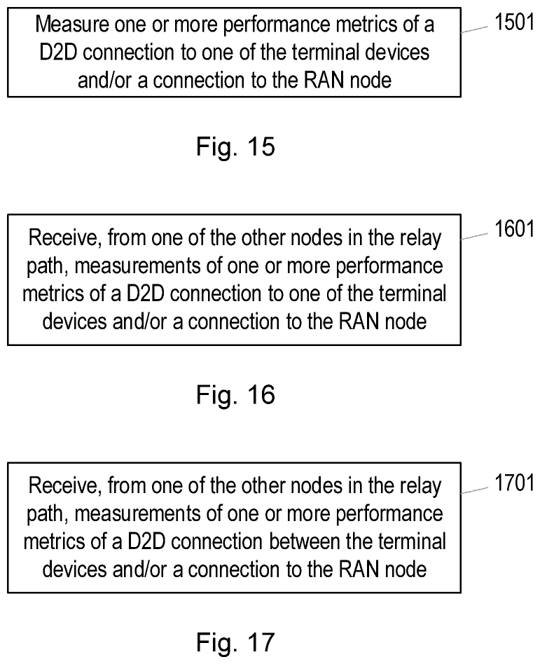

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g. in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs). The processing circuitry 1202 may be operable to provide, either alone or in conjunction with other UE 1200 components, such as the memory 1210, to provide UE 1200 functionality. For example, the processing circuitry 1202 may be configured to cause the UE 1202 to perform the methods as described with reference to FIGS. 15 and/or 16.

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g. a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g. an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network, another terminal device/UE or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g. another UE or a network node in an access network). Each transceiver may include a transmitter 1218 and/or a receiver 1220 appropriate to provide network communications (e.g. optical, electrical, frequency allocations, and so forth). Moreover, the transmitter 1218 and receiver 1220 may be coupled to one or more antennas (e.g. antenna 1222) and may share circuit components, software or firmware, or alternatively be implemented separately.

In some embodiments, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g. once every 15 minutes if it reports the sensed temperature), random (e.g. to even out the load from reporting from several sensors), in response to a triggering event (e.g. when moisture is detected an alert is sent), in response to a request (e.g. a user initiated request), or a continuous stream (e.g. a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

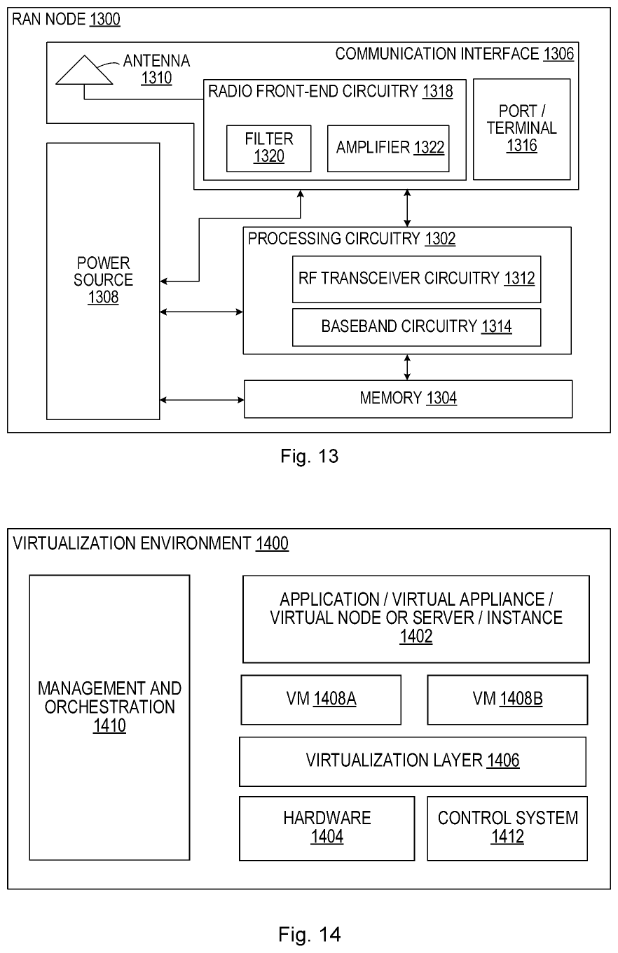

FIG. 13 shows a network node 1300 in accordance with some embodiments. As used herein, network node refers to equipment capable, configured, arranged and/or operable to communicate directly or indirectly with a UE and/or with other network nodes or equipment, in a communication network. Examples of network nodes include, but are not limited to, access network nodes such as access points (APs) (e.g. radio access points), base stations (BSs) (e.g. radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The network node 1300 includes processing circuitry 1302, a memory 1304, a communication interface 1306, and a power source 1308, and/or any other component, or any combination thereof. The network node 1300 may be composed of multiple physically separate components (e.g. a NodeB component and a RNC component, or a BTS component and a BSC component, etc.), which may each have their own respective components. In certain scenarios in which the network node 1300 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g. separate memory 1304 for different RATs) and some components may be reused (e.g. a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality. For example, the processing circuitry 1302 may be configured to cause the network node to perform the methods as described with reference to FIG. 17.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signalling and/or data between network nodes, the access network, the core network, and/or a UE. As illustrated, the communication interface 1306 comprises port(s)/terminal(s) 1316 to send and receive data, for example to and from a network over a wired connection.

In embodiments, the communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the access network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown). The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g. at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g. the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as an access network node, a terminal device/UE, or a core network node. Further, in embodiments in which the virtual node does not require radio connectivity (e.g. a core network node), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 1412 which may alternatively be used for communication between hardware nodes and radio units.

Although the computing devices described herein (e.g. UEs, RAN nodes, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination.

Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In a first set of embodiments, for a relay service or flow which is transmitted over a relay path comprising at least two hops, e.g. as shown in FIGS. 10(a) and (b), a UE (which can be a remote UE 1001, or relay UE 1002, 1004, 1005) is configured to monitor and provide measurement results by taking into account QoS performance to other UEs or nodes (e.g. RAN nodes) on the relay path. That is, a UE can measure one or more performance metrics for a connection from the UE to another UE or node in the relay path. In some embodiments, the one or more performance metrics can be measured by the UE continuously or periodically. In alternative embodiments (as outlined further below), the one or more performance metrics can be measured by the UE on request from, or when polled by, another node (e.g. another UE, or a RAN node). The UE may send those measurements or measurement results to another UE or node in the relay path (in some embodiments, as outlined below, this sending may be in response to a measurement event trigger occurring). The UE can be configured to monitor and provide the measurements by the gNB (or other RAN node) in the relay path, for example on receipt of a measurement configuration from the gNB, or the UE can be preconfigured to monitor and provide the measurements. The measurement results or measurements can be obtained or collected in terms of any of the following performance metrics:
Session level bit rate;
Bit rate on the concerned PC5 link;
Aggregated bit rate on the PC5 interface (may comprise one or multiple PC5 links);
Bit rate of flows;
Bit rate of radio bearers;
Averaged or maximum packet delay of flows or radio bearers;
Averaged or maximum packet error rate of flows or radio bearers;
Total delivered data volume of concerned flows or radio bearers;
Queuing delay of concerned Logical Channels (LCHs), or Logical Channel Groups (LCGs);
Total number of retransmissions on the concerned LCHs, or LCGs, or radio bearers;
Total number of retransmissions for one or multiple packets of a flow on the concerned LCHs, or LCGs, or radio bearers;
Buffer level of concerned LCHs or LCGs;
Number of hops that one or multiple packets of a flow or service have traversed;
Number of remote UE(s) currently being supported and potential new remote UE(s) to be added;
Time of one or multiple packets of a flow or service have spent on the relay path;
Remaining packet delay or number of hops that one or multiple packets of a flow or service on the relay path;
Packet error rate of flows or radio bearers;
Number of lost packets of flows or radio bearers; and
Ratio of packet loss of flows or radio bearers.

Those skilled in the art will be aware of other types of performance metrics that can be measured for a connection between two UEs or between a UE and a RAN node.

In a second set of embodiments, for measurements or measurement results (e.g. for any one or more of the performance metrics defined above for in the first embodiment), the measurement results may be distributed (i.e. sent or transmitted) along the path. That is, the measurements or measurement results can be sent to one or more other UEs in the relay path or the gNB. The measurements or measurement results can be sent via at least one of the following types of signalling:
(PC5/Uu) RRC signalling;
PC5-S signalling;
MAC CE;
Control PDU of a protocol layer (e.g., SDAP, PDCP, RLC, or an adaptation layer in case of SL relay); and
L1 signalling.

In a third set of embodiments, which may be used in combination with the first and/or second set of embodiments, the measurements or measurement results (e.g. obtained according to the first embodiment) can be obtained or collected by a UE in the relay path continuously, periodically, when a measurement event trigger occurs, on request from another UE or a RAN node, or when polled by another entity (e.g. a peer UE, a gNB, or another UE). A peer UE is the other party in a unicast link. ‘Another UE’ may be another neighbouring UE, but may not have a link to the UE.

In embodiments where the UE can be requested or polled to obtain the measurements, the request or poll can be signalled along the path by an entity (e.g. a peer UE, a gNB, or another UE) using at least one of the following signalling alternatives:
RRC signalling;
PC5-S signalling;
MAC CE;
Control PDU of a protocol layer (e.g., SDAP, PDCP, RLC, or an adaptation layer in case of SL relay); and
L1 signalling.

Based on the measurements received in response to sending the request or poll, an entity (e.g. a peer UE, a gNB, or another UE) can decide which particular relay path (i.e. involving which particular UEs as relay UEs) to use, or which particular serving relay UE to use for relay traffic. The measurements can also or alternatively be used for QoS verification purposes, i.e. to make sure that QoS requirements will be met by the relay path. For example the measurements can be used to determine if a configured limit is not exceeded, i.e., it is used as a form of policing. In case measurement results are to be obtained upon trigger of a measurement event, one or multiple measurement events are introduced for the UE. Some example measurement event triggers are set out below, and any one or more of these can be used to determine when a UE should perform measurements of the one or more performance metrics. In some embodiments, a UE can be configured to use any of the below measurement event triggers by a RAN node.

In one example, a measurement event is triggered, and the measurements are sent to another node (e.g. UE or RAN node) in the relay path, if the measurement of a performance metric (e.g., any one of the performance metrics as described in the first embodiment) is below a given threshold. In some embodiments, the measurement event may only be triggered if the measurement of the performance metric is below the given threshold for at least a configured time period.

In another example, a measurement event is triggered, and the measurements are sent to another node (e.g. UE or RAN node) in the relay path, if the measurement of a performance metric (e.g., any one of the performance metrics as described in the first embodiment) is above a given threshold. In some embodiments, the measurement event may only be triggered if the measurement of the performance metric is above the given threshold for at least a configured time period.

In another example, a measurement event is triggered, and the measurements are sent to another node (e.g. UE or RAN node) in the relay path, if the measurement of a performance metric (e.g., any one of the performance metrics as described in the first embodiment) is above a first threshold and below a second threshold. In some embodiments, the measurement event may only be triggered if the measurement of the performance metric is above the first threshold and below the second threshold for at least a configured time period.

In another example, a measurement event is triggered, and the measurements are sent to another node (e.g. UE or RAN node) in the relay path, if the measurement of a first performance metric (e.g., any one of the performance metrics as described in the first embodiment) is above/below a first threshold (as appropriate) and the measurement of a second performance metric (e.g., another one of the metrics as described in the first embodiment) is above/below (as appropriate) a second threshold. In some embodiments, the measurement event may only be triggered if the measurement of the first performance metric is above/below the first threshold for at least a configured time period and the second performance metric is above/below the second threshold for at least a configured time period.

It will be appreciated that the embodiments are not limited by the above examples, and a measurement event may be triggered when one or multiple performance metrics (e.g., any one or multiple combined metrics as described in the first embodiment) fulfill one or multiple conditions.

In case measurement results are obtained periodically, one or multiple periodic timers can be configured in the UE, based on which the UE performs measurements when one or multiple/all of those timers have expired.

A fourth set of embodiments relate to the distribution or sending of measurements along the relay path. The fourth set of embodiments can be used in combination with any of the above sets of embodiments. In some embodiments, when an intermediate node or UE in the relay path receives a measurement or set of measurements from another UE or intermediate node, the receiving intermediate node or UE forwards the measurement results over the next hop without reading, using or modifying the measurement results.

In alternative embodiments, when an intermediate node or UE in the relay path receives a measurement or set of measurements from another UE or intermediate node, the receiving intermediate node or UE may update the received measurement results, and forward the updated measurement results over the next hop. The UE may update received measurement results by appending new measurement results to the received existing measurement results. These new measurements may be a set of measurements performed over a different link/path to the received measurement results. This means that final node (e.g. RAN node 1300) or UE (e.g. remote UE 1001) that receives the measurements can consider the received measurement result to be the overall measurements along the full relay path. In some embodiments, when appending new measurements, the UE/node may also include any of an identifier (ID) for the UE/node, a measurement identifier for the new measurement(s), the path/hop identifier for the path or hop on which the measurements have been made. This/these identifiers enable the network (e.g. NG-RAN 1003) to perform the breakdown of the QoS in a better way and/or with a finer granularity. For example, the network can allocate an appropriate PDB or PER for each hop.

In a fifth set of embodiments, which can be applied to any of the first, second, third and/or fourth sets of embodiments above, in addition to the measurement results for any of the performance metrics as described in the first embodiment, the measurement results sent along the relay path to another node or UE may also include one or more of:
1) UE IDs associated with the measurement results (i.e. the ID(s) of the UE that obtained the measurements), with the UE IDs being IDs of the remote UE(s) and/or the relay UE(s), etc.;
2) The Flow/RB/LCH ID associated with the measurement results;
3) The type of Flow/RB/LCH associated with the measurement results;
4) The QoS properties (e.g. priority) of the Flow/RB/LCH associated with the measurement results;
5) The failure cause (e.g., certain QoS requirements are not met); and
6) Hop/link ID(s) associated with the measurement results.

In a sixth set of embodiments, which can be applied to any of the above sets of embodiments, a UE or RAN node can examine or analyse measurements received from another UE, and if the measurements of the performance metrics for a flow indicate that one or more QoS requirements for one or more RB(s) and/or flow(s) are unlikely to be met for a transmitting node (which may be a UE or gNB), the remote UE or the relay UE may take one or more of the below recovery actions:
1) release the RB and/or the flow where the failure or risk is being declared/detected;
2) the remote UE remaps the flow from one RB to another RB;
3) the same flow can be prioritized for transmission over other flows on another hop of the same path, if there is a risk that the flow will not meet QoS requirements on one hop;
4) the remote UE selects another relay UE if the number of flows that have trouble meeting the QoS requirements is over a configured threshold;
5) the remote UE selects another path if the number of flows who have trouble to meet the QoS requirements on the path is over a configured threshold;
6) the remote UE selects a direct path (i.e., a direct Uu connection) to the gNB;
7) the remote UE keeps the same relay UE while the relay UE changes to a different BWP/carrier/cell/gNB;
8) the remote UE changes to a different Subcarrier Spacing (SCS) or BWP on the PC5 link;
9) the remote UE and/or the relay UE(s) send an indication to the network (RAN node) or the next node in the relay path to inform the network (RAN node) or node that a new configuration is needed to meet the QoS requirement. In this case each node that receives this indication may apply one of the following options:
   a. Option 1: forward the indication to the next hop without reading, using or modifying the indication;
   b. Option 2: read the indication and update the indication with a status of the hops that the UE can reach before forwarding the indication it to the next node.

The UE (i.e. remote UE or relay UE) may take any of the above actions by itself, or alternatively, the UE can take an action in response to an instruction from the gNB (or other RAN node). The gNB may signal an action to perform to the UE after receiving one or more measurement results.

In a seventh set of embodiments, which can be applied to any of the above sets of embodiments, in case a node or UE on a relay path has collected measurement results from different hops, the node or UE may attempt to formulate an overall evaluation of the performance of the E2E link, i.e., the E2E measurement results. In an example, the measurement results of every hop can be averaged to derive the E2E measurement results. In another example, the measurement results of the worst hop (e.g. the hop with the worst measurement of a performance metric) can be used as the E2E measurement results. In another example, the measurement results of all hops can be summarised to derive the E2E measurement results.

In any of the above embodiments, the signalling between a UE and the gNB or other RAN node can be any of:
RRC signalling;
MAC CE;
Paging message
Control PDU of a protocol layer (e.g., SDAP, PDCP, RLC, or an adaptation layer in case of SL relay); and
L1 signalling on channels such as Physical Random Access Channel (PRACH), PUCCH and PDCCH.

In any of the above embodiments, the signalling between UEs can be any of:
RRC signalling (e.g., PC5-RRC);
PC5-S signalling;
Discovery signalling;
MAC CE;
Control PDU of a protocol layer (e.g., SDAP, PDCP, RLC, or an adaptation layer in case of SL relay); and
L1 signalling on channels such as PSSCH, PSCCH, or PSFCH.

FIG. 15 is a flow chart illustrating a method according to various embodiments performed by a terminal device (UE). The terminal device performing the method in FIG. 15 is referred to as a ‘first terminal device’. The first terminal device may perform the method in response to executing suitably formulated computer readable code. The computer readable code may be embodied or stored on a computer readable medium, such as a memory chip, optical disc, or other storage medium. The computer readable medium may be part of a computer program product.

The first terminal device is a node in a relay path that comprises at least two other nodes. In terms of the method shown in FIG. 15, the first terminal device can be any of the remote UE 1001, the relay UE 1002, relay UE1 1004, relay UE2 1005 and remote UE2 1006 shown in the exemplary arrangements of FIG. 10(a)-(c).

The at least two other nodes comprise a terminal device/UE referred to as a ‘second terminal device’. In the case of a UE-to-network relay arrangement, the at least two other nodes also includes at least one RAN node (e.g. NG-RAN 1003 in FIG. 10(a) and (b)). In the case of a UE-to-UE relay arrangement, the at least two other nodes includes another terminal device/UE referred to as a 'third terminal device'.

In step 1501, the method comprises measuring one or more performance metrics of a D2D connection to one of the terminal devices and/or one or more performance metrics of a connection to the RAN node.

In some embodiments, the one or more performance metrics comprise any of: a session level bit rate; a bit rate on a concerned PC5 link; an aggregated bit rate on a PC5 interface; a bit rate of flows; a bit rate of radio bearers; an averaged or maximum packet delay of flows or radio bearers; an averaged or maximum packet error rate of flows or radio bearers; a total delivered data volume of concerned flows or radio bearers; a queuing delay of concerned Logical Channels, LCHs, or Logical Channel Groups, LCGs; a total number of retransmissions on the concerned LCHs, or LCGs, or radio bearers; a total number of retransmissions for one or multiple packets of a flow on the concerned LCHs, or LCGs, or radio bearers; a buffer level of concerned LCHs or LCGs; a number of hops that one or multiple packets of a flow or service have traversed; a number of remote terminal devices currently being supported and potential new remote terminal devices to be added; a time of one or multiple packets of a flow or service have spent on the relay path; a remaining packet delay or number of hops that one or multiple packets of a flow or service on the relay path; a packet error rate of flows or radio bearers; a number of lost packets of flows or radio bearers; and a ratio of packet loss of flows or radio bearers.

In some embodiments, the method in the first terminal device further comprises sending the measurements of the one or more performance metrics to another node in the relay path (e.g. to the second terminal device, the third terminal device or the RAN node).

In some embodiments, the method further comprises the first terminal device receiving measurements of the one or more performance metrics from one of the other nodes in the relay path. The received measurements relate to a D2D connection between two of the terminal devices or a connection to the RAN node. The first terminal device can then send the received measurements to another one of the nodes in the relay path.

In these embodiments, the first terminal device may send the received measurements to another one of the nodes in the relay path without reading and/or using the received measurements. Alternatively, the first terminal device may update the received measurements to include the measurements obtained by the first terminal device of the one or more performance metrics. The first terminal device then sends the updated measurements to another one of the nodes in the relay path. In some embodiments, the measurements can also be updated to include one or more of an identifier for the first terminal device, a measurement identifier for the measurements obtained by the first terminal device, and an identifier for the connection to which the measurements relate.

In the above embodiments, the measurements can be sent via any of PC5 RRC signalling; Uu RRC signalling, PC5-S signalling; MAC CE; Control PDU of a protocol layer; and Layer 1, L1, signalling.

In some embodiments, the step of sending further comprises sending one or more of: a terminal device ID associated with the measurements; an ID for a flow, RB or LCH associated with the measurements; a type of flow, RB, or LCH associated with the measurements; QoS properties of the flow, RB, or LCH associated with the measurements; a failure cause; and IDs for a hop or link associated with the measurements.

In some embodiments, the first terminal device measures the one or more performance metrics in step 1501 continuously or periodically. In some embodiments, the first terminal device measures the one or more performance metrics in step 1501 in response to a request or poll from one of the other nodes in the relay path.

In some embodiments, the first terminal device sends the measurements of the one or more performance metrics on occurrence of a measurement event trigger, for example any of the measurement event triggers described above.

In some embodiments, the first terminal device evaluates the measurements of the one or more performance metrics, and optionally any measurements received from another node in the relay path, to determine if a QoS requirement for a flow or RB can be met for one or more hops in the relay path. In some embodiments, if it is determined that a QoS requirement cannot be met for one or more hops in the relay path, the first terminal device can perform a recovery action. In alternative embodiments, the first terminal device can receive an indication of a recovery action to perform from the RAN node. The recovery action can be any one or more of: release the RB and/or the flow where a failure or risk is declared/detected; remap the flow from one RB to another RB; prioritise the flow for transmission over other flows on another hop of the relay path; select another terminal device as a relay if the number of flows that cannot meet the QoS requirement is over a configured threshold; select another relay path if the number of flows that cannot meet the QoS requirement on the relay path is over a configured threshold; select a direct path to the RAN node; keep a same relay terminal device while the relay terminal device changes to a different BWP carrier, cell and/or RAN node; change to a different SCS or BWP on a PC5 link; and send an indication to the RAN node or the next node in the relay path to inform the RAN node or node that a new configuration is needed to meet the QoS requirement.

In some embodiments, the method further comprises the first terminal device evaluating the measurements of the one or more performance metrics, and optionally any measurements received from another node in the relay path, to determine a performance of the full relay path.

In some embodiments, the relay path comprises the first terminal device connected to the RAN node or the third terminal device via the second terminal device. In other words, the first terminal device is a remote UE (e.g. remote UE 1001). In these embodiments, step 1501 can comprise measuring one or more performance metrics of the D2D connection to the second terminal device (a relay UE 1002/1004). The first terminal device can then send the measurements of the one or more performance metrics to the second terminal device.

In alternative embodiments, the relay path comprises the second terminal device connected to the RAN node or the third terminal device via the first terminal device. In other words, the first terminal device is a relay UE (e.g. relay UE 1002/1004). In these embodiments, step 1501 comprises measuring one or more performance metrics of the D2D connection to the second terminal device (a remote UE 1001). The first terminal device can then send the measurements of the one or more performance metrics to the second terminal device. Alternatively, or in addition, the first terminal device can send the measurements of the one or more performance metrics to the RAN node or the third terminal device (e.g. remote UE 1001/1006).

FIG. 16 is a flow chart illustrating another method according to various embodiments performed by a terminal device (UE). The terminal device performing the method in FIG. 16 is referred to as a ‘second terminal device’. The second terminal device may perform the method in response to executing suitably formulated computer readable code. The computer readable code may be embodied or stored on a computer readable medium, such as a memory chip, optical disc, or other storage medium. The computer readable medium may be part of a computer program product.

The second terminal device is a node in a relay path that comprises at least two other nodes. In terms of the method shown in FIG. 16, the second terminal device can be any of the remote UE 1001, the relay UE 1002, relay UE1 1004, relay UE2 1005 and remote UE2 1006 shown in the exemplary arrangements of FIGS. 10(a)-(c).

The at least two other nodes comprise a terminal device/UE referred to as a ‘first terminal device’. In the case of a UE-to-network relay arrangement, the at least two other nodes also includes at least one RAN node (e.g. NG-RAN 1003 in FIGS. 10(a) and (b)). In the case of a UE-to-UE relay arrangement, the at least two other nodes includes another terminal device/UE referred to as a ‘third terminal device’.

For completeness, it should be noted that a single UE or terminal device may be configured to perform the method of FIG. 15 and the method of FIG. 16, depending on the relay path arrangement the terminal device is being used in. In step 1601, the method comprises receiving, from one of the other nodes in the relay path, measurements of one or more performance metrics of a D2D connection to one of the terminal devices and/or one or more performance metrics of a connection to the RAN node.

In some embodiments, the one or more performance metrics comprise any of: a session level bit rate; a bit rate on a concerned PC5 link; an aggregated bit rate on a PC5 interface; a bit rate of flows; a bit rate of radio bearers; an averaged or maximum packet delay of flows or radio bearers; an averaged or maximum packet error rate of flows or radio bearers; a total delivered data volume of concerned flows or radio bearers; a queuing delay of concerned Logical Channels, LCHs, or Logical Channel Groups, LCGs; a total number of retransmissions on the concerned LCHs, or LCGs, or radio bearers; a total number of retransmissions for one or multiple packets of a flow on the concerned LCHs, or LCGs, or radio bearers; a buffer level of concerned LCHs or LCGs; a number of hops that one or multiple packets of a flow or service have traversed; a number of remote terminal devices currently being supported and potential new remote terminal devices to be added; a time of one or multiple packets of a flow or service have spent on the relay path; a remaining packet delay or number of hops that one or multiple packets of a flow or service on the relay path; a packet error rate of flows or radio bearers; a number of lost packets of flows or radio bearers; and a ratio of packet loss of flows or radio bearers.

In some embodiments, the received measurements further comprise one or more of an identifier for the node on the relay path from which the measurements are received, a measurement identifier for the measurements obtained by the node on the relay path from which the measurements are received, and an identifier for the connection to which the measurements relate.

In some embodiments, the method further comprises the second terminal device sending the measurements of the one or more performance metrics to another node in the relay path. In some embodiments, the second terminal device can send the received measurements to another one of the nodes in the relay path without reading and/or using the received measurements.

In alternative embodiments, the method in the second terminal device further comprises measuring one or more performance metrics of a D2D connection to one of the other terminal devices and/or one or more performance metrics of a connection to the RAN node. The second terminal device may update the received measurements to include the measurements obtained by the second terminal device, and send the updated measurements to another one of the nodes in the relay path. In some embodiments, the second terminal device can update the received measurements to include one or more of an identifier for the second terminal device, a measurement identifier for the measurements obtained by the second terminal device, and an identifier for the connection to which the measurements relate.

In the above embodiments, the measurements can be sent via any of PC5 RRC signalling; Uu RRC signalling, PC5-S signalling; MAC CE; Control PDU of a protocol layer; and Layer 1, L1, signalling.

In some embodiments, the step of sending further comprises sending one or more of: a terminal device ID associated with the measurements; an ID for a flow, RB or LCH associated with the measurements; a type of flow, RB, or LCH associated with the measurements; QoS properties of the flow, RB, or LCH associated with the measurements; a failure cause; and IDs for a hop or link associated with the measurements.

In some embodiments, the second terminal device evaluates the received measurements of the one or more performance metrics, and optionally any measurements received from another node in the relay path, to determine if a QoS requirement for a flow or RB can be met for one or more hops in the relay path. In some embodiments, if it is determined that a QoS requirement cannot be met for one or more hops in the relay path, the second terminal device can perform a recovery action. In alternative embodiments, the second terminal device can receive an indication of a recovery action to perform from the RAN node. The recovery action can be any one or more of: release the RB and/or the flow where a failure or risk is declared/detected; remap the flow from one RB to another RB; prioritise the flow for transmission over other flows on another hop of the relay path; select another terminal device as a relay if the number of flows that cannot meet the QoS requirement is over a configured threshold; select another relay path if the number of flows that cannot meet the QoS requirement on the relay path is over a configured threshold; select a direct path to the RAN node; keep a same relay terminal device while the relay terminal device changes to a different BWP carrier, cell and/or RAN node; change to a different SCS or BWP on a PC5link; and send an indication to the RAN node or the next node in the relay path to inform the RAN node or node that a new configuration is needed to meet the QoS requirement.

In some embodiments, the method further comprises the second terminal device evaluating the measurements of the one or more performance metrics, and optionally any measurements received from another node in the relay path, to determine a performance of the full relay path.

FIG. 17 is a flow chart illustrating another method according to various embodiments performed by a RAN node (e.g. a gNB). The RAN node may perform the method in response to executing suitably formulated computer readable code. The computer readable code may be embodied or stored on a computer readable medium, such as a memory chip, optical disc, or other storage medium. The computer readable medium may be part of a computer program product.

The RAN node is a node in a relay path that comprises at least two other nodes. The at least two other nodes comprise a terminal device/UE referred to as a ‘first terminal device’ and a terminal device/UE referred to as a ‘second terminal device’. One of these terminal devices is operating as a remote UE, and the other one is operating as a relay UE.

In step 1701, the RAN node receives, from one of the other nodes in the relay path, measurements of one or more performance metrics of a D2D connection between the terminal devices and/or one or more performance metrics of a connection to the RAN node.

In some embodiments, the one or more performance metrics comprise any of: a session level bit rate; a bit rate on a concerned PC5 link; an aggregated bit rate on a PC5 interface; a bit rate of flows; a bit rate of radio bearers; an averaged or maximum packet delay of flows or radio bearers; an averaged or maximum packet error rate of flows or radio bearers; a total delivered data volume of concerned flows or radio bearers; a queuing delay of concerned Logical Channels, LCHs, or Logical Channel Groups, LCGs; a total number of retransmissions on the concerned LCHs, or LCGs, or radio bearers; a total number of retransmissions for one or multiple packets of a flow on the concerned LCHs, or LCGs, or radio bearers; a buffer level of concerned LCHs or LCGs; a number of hops that one or multiple packets of a flow or service have traversed; a number of remote terminal devices currently being supported and potential new remote terminal devices to be added; a time of one or multiple packets of a flow or service have spent on the relay path; a remaining packet delay or number of hops that one or multiple packets of a flow or service on the relay path; a packet error rate of flows or radio bearers; a number of lost packets of flows or radio bearers; and a ratio of packet loss of flows or radio bearers.

In some embodiments, step 1701 further comprises receiving one or more of: a terminal device ID associated with the measurements; an ID for a flow, RB or LCH associated with the measurements; a type of flow, RB, or LCH associated with the measurements; QoS properties of the flow, RB, or LCH associated with the measurements; a failure cause; and IDs for a hop or link associated with the measurements.

In some embodiments, the received measurements further comprise one or more of an identifier for the node on the relay path from which the measurements are received, a measurement identifier for the measurements obtained by the node on the relay path from which the measurements are received, and an identifier for the connection to which the measurements relate.

In some embodiments, the method further comprises sending a measurement configuration to one or more of the first terminal device and the second terminal device. The measurement configuration relates to the measurement of one or more performance metrics by the first terminal device or the second terminal device. For example, the measurement configuration can indicate a particular performance metric or metrics for the terminal device to measure. As another example, the measurement configuration can indicate a measurement event trigger than can be used by the terminal device to determine when measurements are to be sent to another node in the relay path.

In some embodiments, the RAN node also evaluate the received measurements of the one or more performance metrics to determine if a QoS requirement for a flow or RB can be met for one or more hops in the relay path. If it is determined that a QoS requirement cannot be met for one or more hops in the relay path, the RAN node can send an indication of a recovery action to perform to the first terminal device and/or the second terminal device. The recovery action can be any one or more of: release the RB and/or the flow where a failure or risk is declared/detected; remap the flow from one RB to another RB; prioritise the flow for transmission over other flows on another hop of the relay path; select another terminal device as a relay if the number of flows that cannot meet the QoS requirement is over a configured threshold; select another relay path if the number of flows that cannot meet the QoS requirement on the relay path is over a configured threshold; select a direct path to the RAN node; keep a same relay terminal device while the relay terminal device changes to a different BWP carrier, cell and/or RAN node; change to a different SCS or BWP on a PC5 link; and send an indication to the RAN node or the next node in the relay path to inform the RAN node or node that a new configuration is needed to meet the QoS requirement. In some embodiments, step 1701 comprises receiving the measurements via any of Uu RRC signalling; MAC CE; Control PDU of a protocol layer; and L1 signalling.

In some embodiments, the RAN node evaluates the received measurements, and optionally any measurements received from another node in the relay path, to determine a performance of the full relay path.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 720 causes the first terminal device 700 to perform the actions, e.g., of the procedure described earlier in conjunction with FIG. 3; or code/computer readable instructions, which when executed by the processor 820 causes the second terminal device 800 to perform the actions, e.g., of the procedure described earlier in conjunction with FIG. 4; or code/computer readable instructions, which when executed by the processor 920 causes the network node or control device 900 to perform the actions, e.g., of the procedure described earlier in conjunction with FIG. 5; or code/computer readable instructions, which when executed by the processing circuitry 1202 causes the terminal device 1200 to perform the actions, e.g., of the procedure described earlier in conjunction with FIG. 15 or 16; or code/computer readable instructions, which when executed by the processing circuitry 1302 causes the RAN node 1300 to perform the actions, e.g., of the procedure described earlier in conjunction with FIG. 17.

The computer program product may be configured as a computer program code structured in computer program modules. The computer program modules could essentially perform the actions of the flow illustrated in any of FIGS. 3-5 and 15-17.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

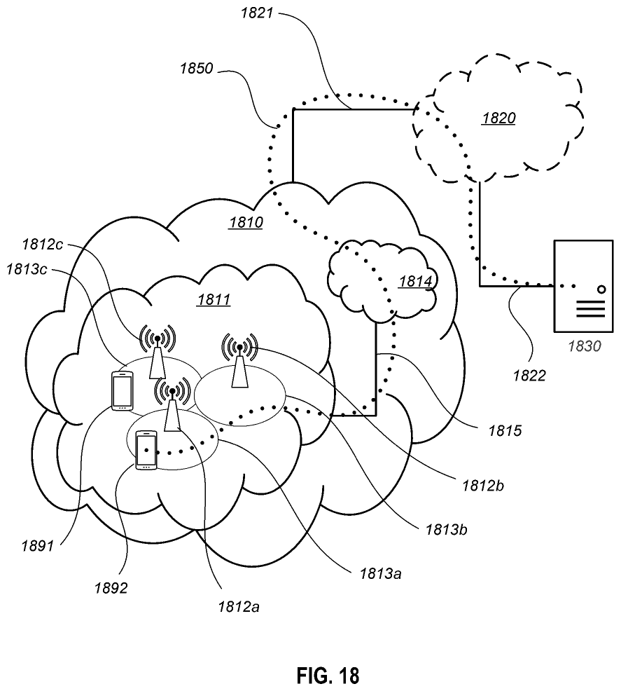

With reference to FIG. 18, in accordance with an embodiment, a communication system includes a telecommunication network 1810, such as a 3GPP-type cellular network, which comprises an access network 1811, such as a radio access network, and a core network 1814. The access network 1811 comprises a plurality of base stations 1812a, 1812b, 1812c, such as NBs, eNBs, gNBs or other types of wireless access points, each defining a corresponding coverage area 1813a, 1813b, 1813c. Each base station 1812a, 1812b, 1812c is connectable to the core network 1814 over a wired or wireless connection 1815. A first user equipment (UE) 1891 located in coverage area 1813c is configured to wirelessly connect to, or be paged by, the corresponding base station 1812c. A second UE 1892 in coverage area 1813a is wirelessly connectable to the corresponding base station 1812a. While a plurality of UEs 1891, 1892 are illustrated in this example, the disclosed embodiments are equally applicable to a situation where a sole UE is in the coverage area or where a sole UE is connecting to the corresponding base station 1812.

The telecommunication network 1810 is itself connected to a host computer 1830, which may be embodied in the hardware and/or software of a standalone server, a cloud-implemented server, a distributed server or as processing resources in a server farm. The host computer 1830 may be under the ownership or control of a service provider, or may be operated by the service provider or on behalf of the service provider. The connections 1821, 1822 between the telecommunication network 1810 and the host computer 1830 may extend directly from the core network 1814 to the host computer 1830 or may go via an optional intermediate network 1820. The intermediate network 1820 may be one of, or a combination of more than one of, a public, private or hosted network; the intermediate network 1820, if any, may be a backbone network or the Internet; in particular, the intermediate network 1820 may comprise two or more sub-networks (not shown).

The communication system of FIG. 18 as a whole enables connectivity between one of the connected UEs 1891, 1892 and the host computer 1830. The connectivity may be described as an over-the-top (OTT) connection 1850. The host computer 1830 and the connected UEs 1891, 1892 are configured to communicate data and/or signaling via the OTT connection 1850, using the access network 1811, the core network 1814, any intermediate network 1820 and possible further infrastructure (not shown) as intermediaries. The OTT connection 1850 may be transparent in the sense that the participating communication devices through which the OTT connection 1850 passes are unaware of routing of uplink and downlink communications. For example, a base station 1812 may not or need not be informed about the past routing of an incoming downlink communication with data originating from a host computer 1830 to be forwarded (e.g., handed over) to a connected UE 1891. Similarly, the base station 1812 need not be aware of the future routing of an outgoing uplink communication originating from the UE 1891 towards the host computer 1830.

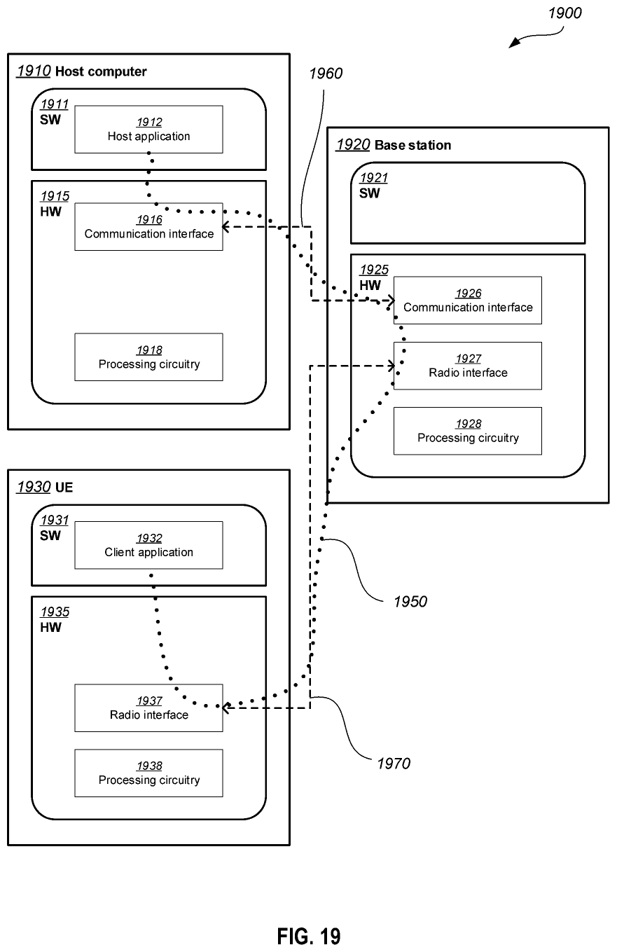

Example implementations, in accordance with an embodiment, of the UE, base station and host computer discussed in the preceding paragraphs will now be described with reference to FIG. 19. In a communication system 1900, a host computer 1910 comprises hardware 1915 including a communication interface 1916 configured to set up and maintain a wired or wireless connection with an interface of a different communication device of the communication system 1900. The host computer 1910 further comprises processing circuitry 1918, which may have storage and/or processing capabilities. In particular, the processing circuitry 1918 may comprise one or more programmable processors, application-specific integrated circuits, field programmable gate arrays or combinations of these (not shown) adapted to execute instructions. The host computer 1910 further comprises software 1911, which is stored in or accessible by the host computer 1910 and executable by the processing circuitry 1918. The software 1911 includes a host application 1912. The host application 1912 may be operable to provide a service to a remote user, such as a UE 1930 connecting via an OTT connection 1950 terminating at the UE 1930 and the host computer 1910. In providing the service to the remote user, the host application 1912 may provide user data which is transmitted using the OTT connection 1950.

The communication system 1900 further includes a base station 1920 provided in a telecommunication system and comprising hardware 1925 enabling it to communicate with the host computer 1910 and with the UE 1930. The hardware 1925 may include a communication interface 1926 for setting up and maintaining a wired or wireless connection with an interface of a different communication device of the communication system 1900, as well as a radio interface 1927 for setting up and maintaining at least a wireless connection 1970 with a UE 1930 located in a coverage area (not shown in FIG. 19) served by the base station 1920. The communication interface 1926 may be configured to facilitate a connection 1960 to the host computer 1910. The connection 1960 may be direct or it may pass through a core network (not shown in FIG. 19) of the telecommunication system and/or through one or more intermediate networks outside the telecommunication system. In the embodiment shown, the hardware 1925 of the base station 1920 further includes processing circuitry 1928, which may comprise one or more programmable processors, application-specific integrated circuits, field programmable gate arrays or combinations of these (not shown) adapted to execute instructions. The base station 1920 further has software 1921 stored internally or accessible via an external connection.

The communication system 1900 further includes the UE 1930 already referred to. Its hardware 1935 may include a radio interface 1937 configured to set up and maintain a wireless connection 1970 with a base station serving a coverage area in which the UE 1930 is currently located. The hardware 1935 of the UE 1930 further includes processing circuitry 1938, which may comprise one or more programmable processors, application-specific integrated circuits, field programmable gate arrays or combinations of these (not shown) adapted to execute instructions. The UE 1930 further comprises software 1931, which is stored in or accessible by the UE 1930 and executable by the processing circuitry 1938. The software 1931 includes a client application 1932. The client application 1932 may be operable to provide a service to a human or non-human user via the UE 1930, with the support of the host computer 1910. In the host computer 1910, an executing host application 1912 may communicate with the executing client application 1932 via the OTT connection 1950 terminating at the UE 1930 and the host computer 1910. In providing the service to the user, the client application 1932 may receive request data from the host application 1912 and provide user data in response to the request data. The OTT connection 1950 may transfer both the request data and the user data. The client application 1932 may interact with the user to generate the user data that it provides.

It is noted that the host computer 1910, base station 1920 and UE 1930 illustrated in FIG. 19 may be identical to the host computer 1830, one of the base stations 1812a, 1812b, 1812c and one of the UEs 1891, 1892 of FIG. 18, respectively. This is to say, the inner workings of these entities may be as shown in FIG. 11 and independently, the surrounding network topology may be that of FIG. 18.

In FIG. 19, the OTT connection 1950 has been drawn abstractly to illustrate the communication between the host computer 1910 and the use equipment 1930 via the base station 1920, without explicit reference to any intermediary devices and the precise routing of messages via these devices. Network infrastructure may determine the routing, which it may be configured to hide from the UE 1930 or from the service provider operating the host computer 1910, or both. While the OTT connection 1950 is active, the network infrastructure may further take decisions by which it dynamically changes the routing (e.g., on the basis of load balancing consideration or reconfiguration of the network).

The wireless connection 1970 between the UE 1930 and the base station 1920 is in accordance with the teachings of the embodiments described throughout this disclosure. One or more of the various embodiments improve the performance of OTT services provided to the UE 1930 using the OTT connection 1950, in which the wireless connection 1970 forms the last segment. More precisely, the teachings of these embodiments may improve the radio resource utilization and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 1950 between the host computer 1910 and UE 1930, in response to variations in the measurement results. The measurement procedure and/or the network functionality for reconfiguring the OTT connection 1950 may be implemented in the software 1911 of the host computer 1910 or in the software 1931 of the UE 1930, or both. In embodiments, sensors (not shown) may be deployed in or in association with communication devices through which the OTT connection 1950 passes; the sensors may participate in the measurement procedure by supplying values of the monitored quantities exemplified above, or supplying values of other physical quantities from which software 1911, 1931 may compute or estimate the monitored quantities. The reconfiguring of the OTT connection 1950 may include message format, retransmission settings, preferred routing etc.; the reconfiguring need not affect the base station 1920, and it may be unknown or imperceptible to the base station 1920. Such procedures and functionalities may be known and practiced in the art. In certain embodiments, measurements may involve proprietary UE signaling facilitating the host computer's 1911 measurements of throughput, propagation times, latency and the like. The measurements may be implemented in that the software 1911, 1931 causes messages to be transmitted, in particular empty or ‘dummy’ messages, using the OTT connection 1950 while it monitors propagation times, errors etc.

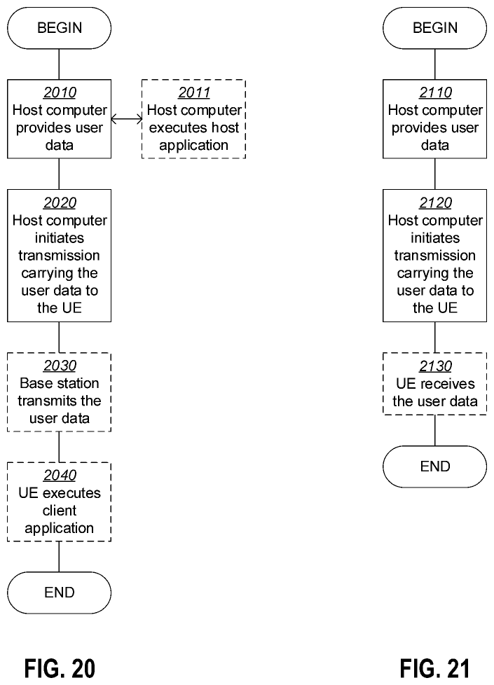

FIG. 20 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 20 will be included in this section. In a first step 2010 of the method, the host computer provides user data. In an optional substep 2011 of the first step 2010, the host computer provides the user data by executing a host application. In a second step 2020, the host computer initiates a transmission carrying the user data to the UE. In an optional third step 2030, the base station transmits to the UE the user data which was carried in the transmission that the host computer initiated, in accordance with the teachings of the embodiments described throughout this disclosure. In an optional fourth step 2040, the UE executes a client application associated with the host application executed by the host computer.

FIG. 21 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 21 will be included in this section. In a first step 2110 of the method, the host computer provides user data. In an optional substep (not shown) the host computer provides the user data by executing a host application. In a second step 2120, the host computer initiates a transmission carrying the user data to the UE. The transmission may pass via the base station, in accordance with the teachings of the embodiments described throughout this disclosure. In an optional third step 2130, the UE receives the user data carried in the transmission.

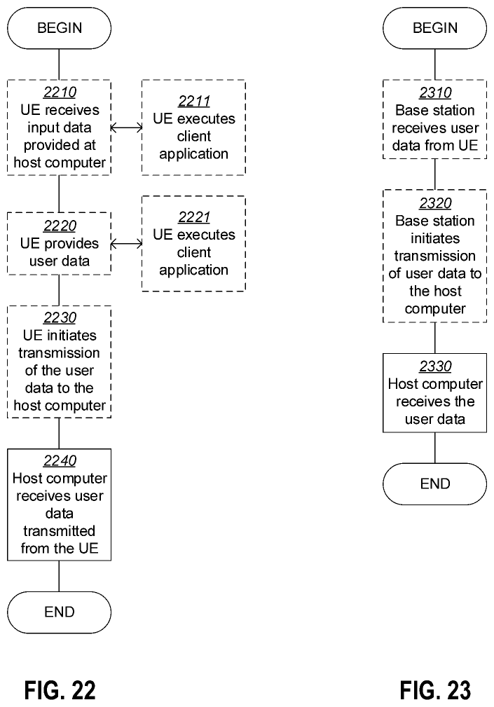

FIG. 22 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 22 will be included in this section. In an optional first step 2210 of the method, the UE receives input data provided by the host computer. Additionally or alternatively, in an optional second step 2220, the UE provides user data. In an optional substep 2221 of the second step 2220, the UE provides the user data by executing a client application. In a further optional substep 2211 of the first step 2210, the UE executes a client application which provides the user data in reaction to the received input data provided by the host computer. In providing the user data, the executed client application may further consider user input received from the user. Regardless of the specific manner in which the user data was provided, the UE initiates, in an optional third substep 2230, transmission of the user data to the host computer. In a fourth step 2240 of the method, the host computer receives the user data transmitted from the UE, in accordance with the teachings of the embodiments described throughout this disclosure.

FIG. 23 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 23 will be included in this section. In an optional first step 2310 of the method, in accordance with the teachings of the embodiments described throughout this disclosure, the base station receives user data from the UE. In an optional second step 2320, the base station initiates transmission of the received user data to the host computer. In a third step 2330, the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

The present disclosure further provides the following embodiments.

The embodiments are described in the context of NR, i.e., two or more SL UEs are deployed in a same or different NR cell. However, the same principle may be applied to LTE or any other technology that enables the direct connection of two (or more) nearby devices. The embodiments are also applicable to relay scenarios including UE to network relay or UE to UE relay where the remote UE and the relay UE may be based on LTE sidelink or NR sidelink, the Uu connection between the relay UE and the base station may be LTE Uu or NR Uu.

We use the terms “direct connection” or “direct path” to stand for a connection between a UE and a gNB, while we use the terms “indirect connection” or “indirect path” to stand for a connection between a remote UE and gNB via a relay UE. Further, we use the term “relay traffic or relay service/flow” to stand for the traffic originating at the remote UE and the term “non-relay traffic or non-relay service/flow”to stand for the traffic originating at the relay UE itself.

The following embodiments are applicable to L2 based U2N or U2U relay scenarios where E2E QoS requirements need to be maintained.

The proposed solution relates to the assurance/maintenance of QoS requirements under real time conditions in a U2N relaying scenario, where the traffic between the remote UE and relay UE is communicated over two hops i.e., over the PC5 and Uu hop. The remote UE/relay UE limitations in their processing capacities, power efficiencies and lack of sophisticated handling of relay traffic might lead to a loss of QoS differentiation for the different relay traffic.

As a result, to prevent loss of QoS differentiation and maintain the E2E QoS requirements, the proposed solution enables the remote UE/relay UE to map the corresponding relay traffic to one or multiple configured (by gNB) RLC channels. Specifically, the relay UE maps a PC5-RLC channel to one or multiple Uu-RLC channels and the remote UE maps a PC5/Uu SRB(s)/DRB(s) to one or multiple PC5-RLC channels. Depending on the E2E QoS requirements of the relay traffic and buffer handling capability/capacity of the relay UE. The proposed solutions consist of the following aspects:
A remote UE/relay UE transmits the assistance information about the relay traffic to the gNB based on which the gNB can configure one or multiple RLC channels.
A one-to-N mapping, where relay UE maps the relay traffic to N RLC channels with the different RLC channels configured (at the remote UE/relay UE) can be associated with either different gNB(s) (for multi-connectivity) from different RAT(s), carriers (for carrier aggregation (CA)) or different cell(s).
A one-out-of-N mapping, where the remote UE/relay UE maps the relay traffic to one of N RLC channel(s). There are certain conditions under which the remote UE/relay UE performs a one-out-of-N mapping, for example:
   If the QoS requirements on either the PC5 or Uu link in real-time conditions cannot be satisfied.
   If the buffer capacity at the relay UE exceeds a certain threshold/limit.
   Improving power saving/efficiency by choosing the channel with minimum power requirements.

In addition, the multiple RLC channels are mentioned above can either be setup solely for relay traffic or can be shared between relay or non-relay traffic. In the shared case, we also propose a mechanism to differentiate between the two traffic types (i.e., relay and non-relay) at the time of requesting resources as a part of the BSR procedure.

In the first embodiment, the remote UE may send assistance information on relay or non-relay service/flow (shown below in FIG. 1) to the gNB/trusted controlling third UE/road side unit (RSU) via at least one of the following signaling alternatives
RRC signaling
MAC CE
Control PDU of a protocol layer (e.g., SDAP, PDCP, RLC or an adaptation layer)
L1 signaling on physical channels (e.g., PRACH, PUCCH, PUSCH etc)

The signaling comprises at least one of the following information:
(Type) of Services or flows which are to be transmitted by the remote UE
Corresponding QoS requirements of the services or flows
Transmission direction, i.e. UL or DL
Power related information (TX/RX power, PHR, battery status)
ID of the remote UE
ID of the relay UE

In addition, the relay UE may also send the assistance information comprising similar information to the gNB/trusted controlling third UE/RSU.

For every relay service or flow, the gNB/trusted controlling third UE/RSU/relay UE performs a QoS breakdown between the PC5 hop and the PC5/Uu hop for both directions (from the remote UE to the gNB via the relay UE and from the gNB to remote UE via the relay UE) for QoS parameters including at least one of the following
PDB, e.g., access network PDB
PER

The gNB thereafter performs the following configurations for every relay service or flow:
Configurations to the remote UE
   one or multiple PC5-RLC channels
   QoS requirements/parameters and Layer-2 configuration(s) (RLC/MAC/PHY) for the PC5 hop
   One or multiple channel mapping relations between the PC5/Uu SRBs/DRBs carrying the relay service or flow and the above PC5-RLC channels
Configurations to the relay UE
   one or multiple Uu-RLC channels
   QOS requirements/parameters and Layer-2 configuration(s) (RLC/MAC/PHY) for the Uu hop
   One or multiple channel mapping relations between the PC5-RLC channels (i.e., as configured to communicate with the remote UE) and the above PC5/Uu-RLC channels
Configurations at the gNB
   one or multiple PC5-RLC channels

The above mapping relations may be one to one mapping, one to many mappings or many to one mapping.

For each relay service or flow, the above configured (PC5/Uu) RLC channels can be associated with either the same or different gNB(s) of same/different RAT(s) (DC, EN-DC, NE-DC) or same/different carriers (CA).

The multiple RLC-channels (i.e., PC5 RLC channels (remote UE) and/or Uu RLC channels (relay UE)) can be either setup specifically for the relay service/flow or shared between the relay and non-relay service/flow.

The different relay services or flows may be mapped to the same set of RLC channels (i.e., PC5-RLC channels and/or Uu RLC channels).

In the second embodiment of the proposed mechanism, a selection mechanism is proposed for the UE (i.e., remote UE and/or relay UE) to select one or more most suitable mapping relation(s) out of N mapping relations for every relay service or flow according to at least one of the following conditions/measurement results
Short term radio channel conditions in terms of metrics such as RSRQ, RSRP, RSSI, SINR, SIR etc
Short term congestion metrics in terms of channel busy ratio (CBR), channel usage ratio (CR) etc
Other L1 measurement metrics (e.g., HARQ NACK ratio)
Other QoS metrics (e.g., packet loss, packet delay, packet error rate etc)
Buffer status
Power headroom or Power efficiency—choose the ith channel with minimum power requirements
UE's mobility status (e.g., moving speed)
UE's location
UE needs to perform a reconfiguration of the link (PC5/Uu)
A threshold linked to the buffer status or any other metrics listed above

For the remote UE, the above conditions are referring to the PC5-hop, while for the relay UE, the above conditions are referring to either the PC5-hop or the Uu hop or both.

Each of the N RLC bearers/channels can be setup with different Layer-2 configurations like different priority levels.

The selection may be performed once for every Mth PDCP PDU carrying relay service or during a period, where M and the period is configured by the NW/another UE or preconfigured in the relay UE/remote UE.

For the remote UE, according to the selection mechanism, for a relay service or flow, the remote UE selects one or more most suitable mapping relations between the PC5/Uu SRBs/DRBs (carrying the relay service or flow) and the PC5-RLC channel(s) and transmits the PDCP PDU carrying relay service over the selected one or more PC5-RLC channel(s).

For the relay UE, according to the selection mechanism, for the relay service or flow, the relay UE selects one or more most suitable mapping relations between the PC5-RLC channels and Uu-RLC channels and transmits the PDCP PDU carrying relay service received over PC5-RLC channel(s)/Uu-RLC channel(s) on the selected Uu-RLC channel(s)/PC5-RLC channel(s) mapped to the corresponding PC5-RLC channel(s)/Uu-RLC channel(s).

For a same relay service or flow, it may be either the remote UE or the relay UE to perform selection at a time. It may also be possible that both the remote UE and the relay UE to perform selection at the same time. In this case, the remote UE may perform selection prior to the relay UE (for UL).

Another aspect of the second embodiment is that the N Uu-RLC bearers/channels are setup and can be shared between the relay and non-relay service/flow.

In the uplink path, the remote UE can dynamically select one RLC channel out of the multiple configured RLC channels. In the downlink path, the gNB can dynamically select on RLC channel out of the multiple configured RLC channels. The relay UE can either monitor all the configured RLC channel(s) or can be signaled as to which RLC channel is required to be monitored. The signal can either be a MAC CE, physical layer signal (DCI) or RRC signaling.

In the third embodiment, after the remote UE or the relay UE has selected or reselected a mapping relation, they may indicate to the gNB on what RLC channel has been selected.

The relay UE indicates to the gNB as to which Uu-RLC bearer it has selected via Uu-RRC signaling, MAC CE, control PDU of a protocol layer (e.g., SDAP, PDCP, RLC or the adaptation layer), L1 signaling (e.g., on PRACH, PUCCH, PUSCH). for example,
The indication can be a part of the buffer status report (BSR) before data transmission (MAC CE)
The indication can be a part of the adaptation layer header during data transmission (Control PDU)
The indication can be a part of the MAC header during data transmission (Data PDU)

In addition, the remote UE/the relay UE may also indicate to the relay UE/the remote UE of the selected RLC channel via PC5-RRC signaling, MAC CE, control PDU of a protocol layer (e.g., SDAP, PDCP, RLC or the adaptation layer), L1 signaling (e.g., on PSSCH, PSCCH, PSFCH etc).

When the relay UE or remote UE indicates to the gNB that one (or more, or all) the RLC bearers are used, the indication may come before the UE starts to transmit traffic over such bearers. How earlier the relay UE or remote UE indicates to the gNB can be configured by a timer (configured by the gNB or pre-configured or hardcoded in the spec) and basically the gNB and UE can start to receive a transmit traffic over that used RLC bearer(s) only after the timer has expired (i.e., the timer is started when the relay UE or remote UE send the indication to the gNB).

In the fourth embodiment, for a relay service or flow, there is only selected RLC channels to be active out of all the configured RLC channels at a time. To save power, those unselected RLC channels can be suspended or deactivated. The multiple configured RLC channels can be active either:
Option 1. All at the same time
Option 2. Only a portion of them
Option 3. Only one RLC radio bearer at the time.

Which option the UE should perform may be decided directly by the gNB/another UE that sent the configuration for the RLC radio bearers, or by the remote UE and/or relay UE themselves based on the rules configured by the gNB/another UE or predefined in the remote UE and/or relay UE. It is worth to clarify that even if the remote UE and/or relay UE receive a configuration to setup “N” RLC radio bearers, the one that are not used are not physically setup, but the configuration is rather stored in the UE memory. The RLC radio bearers are setup only when the RLC radio bearer is really needed i.e., whenever the UE has determined to reselect an RLC channel that is currently unselected, that RLC channel needs to be resumed or reactivated.

In the fifth embodiment, measurement results (comprising at least one of the information as described in the second embodiment) of one hop is signaled to the other hop as inputs to assist the selection mechanism. In an example, the remote UE measures the PC5 hop, and provides the measurement results to the relay UE.

In another example, the relay UE measures the Uu hop, and provides the measurement results to the remote UE.

In the sixth embodiment of the proposed mechanism, at the relay UE, the gNB can configure a mapping between the PC5-RLC channel, a first Uu-RLC channel and a second Uu-RLC channel. The priority of the second Uu-RLC channel being higher/lower than the first Uu-RLC channel depending on whether for example QoS/lower efficiency requirements are to be satisfied. In addition, the second Uu-RLC channel can be shared between relay and non-relay service/flow. However, the relay UE can select the second Uu-RLC channel to transmit the relay service/flow to only under certain real-time conditions like:
If the real-time PDB or PER on either of the two links i.e., PC5 and Uu exceeds or is below a certain limit
If the buffer capacity of the relay UE is exceeded or crosses a certain threshold
If the power efficiency or battery power reduces below a specified threshold

This embodiment can also be extended to a third, fourth and other Uu-RLC channel(s) with similar conditions for selection.

Similar mechanisms as described above could also be applied to the remote UE, when the remote UE is configured with a mapping between the PC5/Uu SRBs/DRBs, a first PC5-RLC channel and a second PC5-RLC channel, where the second PC5-RLC channel can be shared between relay and non-relay service/flow. In this case, the remote UE can select the second PC5-RLC channel only under certain real-time conditions as listed above.

In the seventh embodiment of the proposed mechanism, a relay UE with a mapping between the PC5-RLC channel and a first Uu-RLC channel can autonomously select a second Uu-RLC channel not configured by the gNB for relay service/flow. That is the second Uu-RLC channel is not included in the mapping configuration by the gNB. The second Uu-RLC channel can have a higher/lower priority than the first depending on the QoS/power efficiency requirements. Similar conditions as in the fifth embodiment apply in terms of selecting the second Uu-RLC channel with the addition that such a Uu-RLC channel should already exist for non-relay service/flow.

Though autonomously chosen by the relay UE, the gNB can also configure the relay UE to perform such an autonomous selection without specifying the exact mapping between the channels (PC5 and Uu). The relay UE can also request the gNB for configuring such an autonomous mode.

Similarly, a remote UE with a mapping between the PC5/Uu SRBs/DRBs and a first PC5-RLC channel can autonomously map the PC5/Uu SRBs/DRBs to a second PC5-RLC channel not configured for relay service/flow.

For the sixth and seventh embodiments, the measurements as described in the second embodiment can also be used to select the second RLC channel at the relay UE/remote UE. However, not confined to second only, selection of the third, fourth and other RLC channel(s) can also be based on the measurements as described in the fourth embodiment.

For the sixth and seventh embodiments, when using any Uu-RLC/PC5-RLC channel but the first Uu-RLC/PC5-RLC channel, the relay UE/remote UE may indicate to the gNB whether the traffic carried on this channel is for relay or non-relay traffic based on the indications as described in the third embodiment.

For the sixth and seventh embodiments, another aspect is that at the remote UE/relay UE in case the first RLC channel is unavailable for a period due to a reconfiguration of the link (both PC5 and Uu, via an RRCReconfiguration message), the relay UE/remote UE can select the second RLC channel for reasons including but not limited to the following:
PC5/Uu Layer-2 configuration update for example, update priorities levels
Updates the QoS parameters over the PC5/Uu links

The second RLC channel can be shared between relay and non-relay services/flows.

In an eighth embodiment which is applicable to all the above, whether the RLC channel (PC5/Uu) is shared between relay and non-relay service/flow, the remote UE/relay UE can indicate to the gNB for which traffic the resources are being requested. This can be done by the following:
Assignment of different logical channel groups (LCG(s)) to relay and non-relay flow/service
An additional field in the BSR MAC CE indicating in addition to the LCG ID and buffer size, the type of traffic i.e., relay or non-relay
Introducing two LCIDs for BSR MAC CE, the different LCIDs representing for which traffic the resources are being requested.

In the ninth embodiment, for any of the above embodiments, the signaling alternatives described will include at least one of the below

For signaling between UE and the gNB:
RRC signaling
MAC CE
Paging message
Control PDU of a protocol layer (e.g., SDAP, PDCP, RLC, or an adaptation layer in case of SL relay)
L1 signaling on channels such as PRACH, PUCCH, PDCCH

For signaling between UEs:
RRC signaling (e.g., PC5-RRC)
PC5-S signaling
Discovery signaling
MAC CE
Control PDU of a protocol layer (e.g., SDAP, PDCP, RLC, or an adaptation layer in case of SL relay)
L1 signaling on channels such as PSSCH, PSCCH, or PSFCH.

With proposed mechanisms, we can achieve the following benefits:
Based on assistance information from the remote UE/relay UE, the gNB can configure multiple RLC channels for relay traffic at the remote UE(s)/relay UE(s) enabling them to maintain the E2E QoS requirements (i.e., over PC5 and Uu) without the need for an RRCReconfiguration (both on Uu/PC5) which leads to significant delays, packet loss and signaling overhead. The multiple RLC channels can be shared between the relay and non-relay traffic.
The one-to-N mapping enables the remote UE(s)/relay UE(s) to make use of the advanced communication mechanisms especially on the Uu interface like Inter-RAT/Intra-RAT dual connectivity (DC) and carrier aggregation (CA)
The one-out-of-N mapping allows the remote UE(s)/relay UE(s) under certain conditions to select a specific RLC channel (out of N) to transmit relay traffic based on the E2E QoS requirements, power efficiency or buffer capacity. This specific Uu-RLC channel can be shared between relay and non-relay traffic. In addition, the unused channel can be kept in a state we call deactivated and can be reactivated based on signaling between the remote UE/relay UE and gNB.
The one-out-of-N mapping also allows the remote UE(s)/relay UE(s) under certain conditions to map the relay traffic to an RLC channel associated with non-relay traffic. That is, the remote UE/relay UE autonomously maps the relay traffic to an RLC channel to which it was not configured to use.
When the RLC channel is shared between relay and non-relay traffic, we propose modifications in the Buffer Status Reporting (BSR) procedure to enable the gNB to understand for whom (i.e., either the remote UE or relay UE) the resources are being requested and thereby enables the gNB to make better scheduling decisions.

1-64. (canceled)

65. A method in a first terminal device having a second terminal device as a relay towards a network node or a third terminal device, comprising:
receiving, from the network node, the second terminal device, or a control device, a configuration for a service or flow relayed by the second terminal device from/to the first terminal device, wherein the configuration comprises:
one or more PC5-Radio Link Control, RLC, channels,
one or more Quality of Service, QoS, requirements or parameters and Layer-2 configurations for a first link between the first terminal device and the second terminal device, and/or
a plurality of mappings each between one or more radio bearers carrying the service or flow and at least one of the one or more PC5-RLC channels;
selecting at least one mapping from the plurality of mappings for the service or flow; and
transmitting one or more Packet Data Convergence Protocol (PDCP) Protocol Data Units (PDUs) carrying the service or flow over the at least one PC5-RLC and/or Uu-RLC channel in the selected at least one mapping.

66. The method of claim 65, wherein the configuration further comprises:
one or more Uu-RLC channels,
one or more QoS requirements or parameters and Layer-2 configurations for a second link between the first terminal device and the network node, and/or
a plurality of mappings each between one or more radio bearers carrying the service or flow and at least one of the one or more Uu-RLC channels.

67. The method of claim 65, wherein the plurality of mappings comprise at least one of: a mapping between one radio bearer and one PC5-RLC and/or Uu-RLC channel, a mapping between more than one radio bearer and one PC5-RLC and/or Uu-RLC channel, or a mapping between one radio bearer and more than one PC5-RLC and/or Uu-RLC channel.

68. The method of claim 65, wherein the at least one mapping is selected based on at least one condition or measurement for the first link and/or the second link, and/or at least one threshold associated with the at least one condition or measurement, the at least one condition or measurement comprising:
one or more short term radio channel conditions,
one or more short term congestion metrics,
one or more Layer-1 measurements,
one or more QoS metrics,
a buffer status,
a power headroom or power efficiency,
a mobility status of the first terminal device,
a location of the first terminal device, or
a need for a link reconfiguration.

69. The method of claim 65, further comprising:
transmitting, to the second terminal device, a mapping indication indicating the selected at least one mapping.

70. The method of claim 65, wherein the plurality of comprise a first mapping between a first radio bearer and a first PC5-RLC or Uu-RLC channel and a second mapping between the first radio bearer and a second PC5-RLC or Uu-RLC channel, the first PC5-RLC or Uu-RLC channel being dedicated for the service or flow and the second PC5-RLC or Uu-RLC channel being sharable between the service or flow and another non-relayed service or flow, and wherein said selecting comprises:
selecting the first mapping or the second mapping based on a first priority of the first PC5-RLC or Uu-RLC channel and a second priority of the second PC5-RLC or Uu-RLC channel, wherein
the first priority is higher than the second priority when a QoS of the service or flow is prioritized over power efficiency of the first terminal device, or the first priority is lower than the second priority when the power efficiency of the first terminal device is prioritized over the QoS of the service or flow.

71. The method of claim 65, further comprising, when a first mapping between a first radio bearer and a first PC5-RLC or Uu-RLC channel is selected, the first PC5-RLC or Uu-RLC channel being dedicated for the service or flow:
reselecting, from the plurality of mappings, a second mapping between the first radio bearer and a second PC5-RLC or Uu-RLC channel, the second PC5-RLC or Uu-RLC channel being sharable between the service or flow and another non-relayed service or flow, or
reselecting a third PC5-RLC or Uu-RLC channel to which the first radio bearer is to be mapped, the third PC5-RLC or Uu-RLC channel being included in none of the plurality of mappings and being sharable between the service or flow and another non-relayed service or flow.

72. A method in a second terminal device serving as a relay for a first terminal device towards a network node or a third terminal device, comprising:
receiving, from the network node or a control device, a second configuration for a service or flow relayed by the second terminal device from/to the first terminal device,
wherein the second configuration comprises at least one of:
one or more Uu/PC5-Radio Link Control, RLC, channels,
one or more Quality of Service, QoS, requirements or parameters and Layer-2 configurations for a third link between the second terminal device and the network node or the third terminal device, and
a plurality of mappings each between one or more PC5-RLC channels and at least one of the one or more Uu/PC5-RLC channels;
selecting at least one mapping from the plurality of mappings in the second configuration for the service or flow; and
transmitting one or more Packet Data Convergence Protocol (PDCP) Protocol Data Units, PDUs of the first terminal device, carrying the service or flow over the at least one Uu/PC5-RLC channel in the selected at least one mapping.

73. The method of claim 72, wherein the plurality of mappings in the second configuration comprise at least one of: a mapping between one PC5-RLC channel and one Uu/PC5-RLC channel, a mapping between more than one PC5-RLC channel and one Uu/PC5-RLC channel, or a mapping between one PC5-RLC channel and more than one Uu/PC5-RLC channel.

74. The method of claim 72, further comprising:
receiving, from the network node or the control device, a first configuration for the service or flow relayed by the second terminal device from/to the first terminal device,
wherein the first configuration comprises at least one of:
one or more PC5-Radio Link Control, RLC, and/or Uu-RLC channels,
one or more Quality of Service, QoS, requirements or parameters and Layer-2 configurations for a first link between the first terminal device and the second terminal device, and
a plurality of mappings each between one or more radio bearers carrying the service or flow and at least one of the one or more PC5-RLC; and
forwarding the first configuration to the first terminal device.

75. The method of claim 72, wherein the plurality of mappings in the first configuration comprise at least one of: a mapping between one radio bearer and one PC5-RLC and/or Uu-RLC channel, a mapping between more than one radio bearer and one PC5-RLC and/or Uu-RLC channel, or a mapping between one radio bearer and more than one PC5-RLC and/or Uu-RLC channel.

76. The method of claim 72, further comprising:
transmitting, to the network node or the control device, a mapping indication indicating the selected at least one mapping; and
starting a timer when the mapping indication is transmitted, wherein
the one or more PDCP PDUs of the first terminal device are transmitted after the timer expires.

77. The method of claim 72, wherein at least one of the one or more Uu/PC5-RLC channels that is not included in the selected at least one mapping is suspended or deactivated.

78. The method of claim 72, wherein the plurality of mappings in the second configuration comprise a first mapping between a first PC5-RLC channel and a first Uu/PC5-RLC channel and a second mapping between the first PC5-RLC channel and a second Uu/PC5-RLC channel, the first Uu/PC5-RLC channel being dedicated for the service or flow and the second Uu/PC5-RLC channel being sharable between the service or flow and another non-relayed service or flow, and wherein said selecting comprises:
selecting the first mapping or the second mapping based on a first priority of the first Uu/PC5-RLC channel and a second priority of the second Uu/PC5-RLC channel.

79. The method of claim 72, further comprising, when a first mapping between a first PC5-RLC channel and a first Uu/PC5-RLC channel is selected, the first Uu/PC5-RLC channel being dedicated for the service or flow:
reselecting, from the plurality of mappings, a second mapping between the first PC5-RLC channel and a second Uu/PC5-RLC channel, the second Uu/PC5-RLC channel being sharable between the service or flow and another non-relayed service or flow, or
reselecting a third Uu/PC5-RLC channel to which the first PC5-RLC channel is to be mapped, the third Uu/PC5-RLC channel being included in none of the plurality of mappings and being sharable between the service or flow and another non-relayed service or flow.

80. A method in a network node or a control device, comprising:
transmitting, to a first terminal device having a second terminal device as a relay towards the network node or a third terminal device, a first configuration for a service or flow relayed by the second terminal device from/to the first terminal device; and/or
transmitting, to the second terminal device, a second configuration for the service flow,
wherein the first configuration comprises at least one of:
one or more PC5-Radio Link Control, RLC, channels,
one or more Quality of Service, QoS, requirements or parameters and Layer-2 configurations for a first link between the first terminal device and the second terminal device, and
a plurality of each between one or more radio bearers carrying the service or flow and at least one of the one or more PC5-RLC channels, from which the first terminal device selects at least one mapping for the service or flow, in order to transmit one or more Packet Data Convergence Protocol (PDCP) Protocol Data Units (PDUs) carrying the service or flow over the at least one PC5-RLC and/or Uu-RLC channel in the selected at least one mapping,
wherein the second configuration comprises at least one of:
one or more Uu/PC5-RLC channels,
one or more QoS requirements or parameters and Layer-2 configurations for a third link between the second terminal device and the network node or the third terminal device, and
a plurality of mappings each between one or more PC5-RLC channels and at least one of the one or more Uu/PC5-RLC channels from which the second terminal device selects at least one mapping in the second configuration for the service or flow, in order to transmit one or more PDCP PDUs of the first terminal device, carrying the service or flow over the at least one Uu/PC5-RLC channel in the selected at least one mapping.

81. The method of claim 80, wherein the first configuration further comprises at least one of:
one or more Uu-RLC channels,
one or more QoS requirements or parameters and Layer-2 configurations for a second link between the first terminal device and the network node, and
a plurality of mappings each between one or more radio bearers carrying the service or flow and at least one of the one or more Uu-RLC channels.

82. The method of claim 80, wherein the first configuration is transmitted to the first terminal device via the second terminal device.

83. The method of claim 80, wherein
the plurality of mappings in the first configuration comprise at least one of: a mapping between one radio bearer and one PC5-RLC and/or Uu-RLC channel, a mapping between more than one radio bearer and one PC5-RLC and/or Uu-RLC channel, or a mapping between one radio bearer and more than one PC5-RLC and/or Uu-RLC channel, and/or
the plurality of mappings in the second configuration comprise at least one of: a mapping between one PC5-RLC channel and one Uu/PC5-RLC channel, a mapping between more than one PC5-RLC channel and one Uu/PC5-RLC channel, or a mapping between one PC5-RLC channel and more than one Uu/PC5-RLC channel.

84. The method of claim 80, further comprising:
receiving, from the first terminal device or the second terminal device, information on the service or flow and/or one or more other relayed or non-relayed services or flows,
wherein the first configuration and/or the second configuration is determined based on the information.

85. A first terminal device, comprising a transceiver, a processor and a memory, the memory comprising instructions executable by the processor whereby the first terminal device is operative to perform the method of claim 65.

86. A computer readable storage medium having computer program instructions stored thereon, the computer program instructions, when executed by a processor in a first terminal device, causing the first terminal device to perform the method of claim 65.

87. A second terminal device, comprising a transceiver, a processor and a memory, the memory comprising instructions executable by the processor whereby the second terminal device is operative to perform the method of claim 72.

88. A computer readable storage medium having computer program instructions stored thereon, the computer program instructions, when executed by a processor in a second terminal device, causing the second terminal device to perform the method of claim 72.

89. A network node or control device, comprising a transceiver, a processor and a memory, the memory comprising instructions executable by the processor whereby the network node or control device is operative to perform the method of claim 80.

90. A computer readable storage medium having computer program instructions stored thereon, the computer program instructions, when executed by a processor in a network node or control device, causing the network node or control device to perform the method of claim 80.
